(19) United States
(12) Patent Application Publication
(10) Pub. No.: US 2014/0258742 A1
(43) Pub. Date: Sep. 11, 2014

(54) HYBRID FIBER OPTIC AND POWER OVER ETHERNET

(71) Applicants: Ching-Yun CHIEN, New Taipei City (TW); Robert PERA, San Jose, CA (US)

(72) Inventors: Ching-Yun CHIEN, New Taipei City (TW); Robert PERA, San Jose, CA (US)

(21) Appl. No.: 14/197,896

(22) Filed: Mar. 5, 2014

Related U.S. Application Data
(60) Provisional application No. 61/772,961, filed on Mar. 5, 2013.

(51) Int. Cl. G06F 1/26

(52) U.S. Cl. CPC G06F 1/266
USPC 713/300

(57) ABSTRACT

Connectors for connecting between devices using optical communication where at least one of the devices is configured to receive power from the connector by one or more power over Ethernet (PoE) contacts in the plug. In some variations, described herein are hybrid fiber optic power over Ethernet (PoE) cables that provide power and optically transmit information between and/or to Ethernet devices. Also described herein are extenders configured to provide optical communication between two (or more) devices where at least one of the devices is configured to receive power from the extender by power over Ethernet.

### CROSS REFERENCE TO RELATED APPLICATIONS

This patent application claims priority to provisional patent application No. 61/772,961, titled “OPTICAL FIBER PROVIDING POWER OVER ETHERNET” and filed on Mar. 5, 2013. This provisional patent application is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Described herein are hybrid cables adapted to provide both optical transmission of Ethernet signals (e.g., broadband signals) and electrical power compatible with the delivery of power over Ethernet (PoE), as well as methods of providing both power and optical transmission of data to an Ethernet device, and well media converters (e.g., extenders) that may be used with the hybrid cables to provide PoE and optical connection between two or more devices. Finally, systems and kits including cables and extenders are also described. The hybrid optical and electrical power cables that may be referred to as fiber optic power over Ethernet cables, or optical power over Ethernet cables.

### BACKGROUND

Power over Ethernet (PoE) enables the safe transfer of DC electrical power along with data over standard network cabling, in which both the data and the power share the same wire, and each is independent and unaffected by the other. PoE may be deployed where access to AC power is inconvenient, expensive or infeasible to supply. For example, PoE can power devices that are located in ceilings, on rooftops, light poles, along fences, pipelines, transit routes and other out-of-the-way locations. The cost of bringing electrical power to each device may be eliminated by powering the equipment through an Unshielded Twisted Pair (UTP) cable.

PoE also provides additional flexibility in use, since it allows devices to be positioned wherever a LAN cable can go, without having to worry about getting power. Further, PoE allows devices to be connected by only an Ethernet cable to the end device, without needing additional power supply components, minimizing cable clutter and saving space. In addition, PoE is safer than some power connection alternatives, as no AC power is needed for outdoor applications, and there is no need to meet electrical building codes, or install power outlets. PoE is also a “green” technology, as PoE supplies low voltage rather than high voltage power to these devices and may provide the means to control power to the device; the result may be reduced consumption of power to devices, and reduced power usage.

PoE typically utilizes standard network cabling, which may be referred to as Ethernet cable, copper network cable, Category 5 or 6 cable, and Unshielded Twisted Pair (UTP). This cabling may connect to a network device through an RJ-45 Port (connector). With standard PoE, Power Sourcing Equipment (PSE) provides, or injects, power in the PoE network.

In 2003 the IEEE ratified the 802.3af PoE standard that allows up to 15.4 Watts of power for each port; in 2009, the IEEE ratified the 802.3at PoE Standard known as PoE+. 802.3at allows devices that require more power than the 15.4 Watts available with 802.3af to operate with PoE. With 802.3at, a powered device (“PD”) can be powered with up to 25.5 Watts. 802.3at is backward compatible with 802.3af. The PSE may be configured to recognize that the PD is “af” and only gives it as much power as it needs. Prior to these standards, several device manufacturers were implementing their own proprietary implementations of PoE, such as Cisco VoIP. Although the IEEE has specified PoE and PoE+ power levels, power levels outside of the IEEE specifications are sometimes used

The PoE or PoE+ power level supplied by a PSE may vary, depending on the power requirement of the PD. For example, an IEEE 802.3af standard-compliant PSE can supply up to 15.4 watts of power, but if the PD is an IP phone that requires only 6 watts then the PSE may supply 6 watts of PoE.

PoE may supports various (e.g., four) powering options using different combinations of the eight contacts on a standard RJ-45 port that connect to four pairs of wire in UTP cabling, including power on contacts 1/2 and 3/6, and power on contacts 4/5 and 7/8. The IEEE PoE standards specify two modes of detection and powering different contacts (pins) and wires.

PoE is a useful technology in powering remote devices, but as with any copper network cable, the cable is limited by the distance and bandwidth. According to the ANSI/TIA/EIA standard for category 5e cable (“Cat-5” cable, TIA/EIA 568-5-A) the maximum length for a cable segment is 100 meters (328 ft). PSE power injectors, even midspan power injectors, do not increase the distance of the data network.

Unfortunately, it is often necessary to run a cable for lengths that are very long (e.g., up to 300 ft). When exposed at this length, the cables may act as antennas for low frequency noise and ESD-events. This can cause Ethernet signaling performance issues and radiated interference issues which may destroy the Ethernet interface of the radio and destroy the entire device.

Thus, although many PoE advocates predict that PoE will become a global, long-term DC power cabling standard, current PoE cables are limited, particularly in the length of the cabling that may be used. Described herein are cables, systems including these cables and methods of using them that may overcome the problems discussed above.

### SUMMARY OF THE DISCLOSURE

The present invention relates to cables configured to concurrently transmit both power and data, wherein the data is transmitted optically (e.g., using fiber optics). For convenience, these cables may be referred to as fiber optic power over internet cables or optical power over internet cables.

In general, a fiber optic power over Ethernet (PoE) cable may provide power and optically communicate data between devices using a single (unitary) cable. For example, a fiber optic power over Ethernet (PoE) cable may include: a first connector having a power contact configured to transmit DC power and one or more data contacts configured to carry electrical signals; a first transceiver connected to the one or more data contacts of the first connector and configured to convert electrical signals into optical signals; an elongate length of hybrid fiber cabling comprising an outer jacket surrounding an optical fiber coupled to the first transceiver and a power line comprising an electrical conductor coupled to the power contact; a second transceiver connected to the optical fiber and configured to convert optical signals from the optical fiber into electrical signals; and a second connector connected to the second transceiver, the second connector having a second power contact connected to the power line.

In some variations, the fiber optic power over Ethernet cable includes: a first connector having a plurality of contacts including a power contact configured to transmit DC power; a first transceiver connected to the first connector and configured to convert electrical signals from the first connector into optical signals and to convert optical signals into electrical signals for transmission to the first connector; an elongate length of hybrid fiber cabling comprising an outer jacket surrounding an optical fiber coupled to the first transceiver at a first end of the optical fiber and a power line comprising an electrical conductor coupled to the power contact of the first connector at a first end; a second transceiver connected to a second end of the optical fiber and configured to convert optical signals from the optical fiber into electrical signals and to convert electrical signals into optical signals for transmission over the optical fiber; and a second connector connected to the second transceiver to send and send and receive electrical signals, the second connector having a power contact connected to the electrical conductor at a second end of the electrical conductor.

Any appropriate connectors may be used for the first and second connectors. For example, the connector may comprise an RJ45 connector. In some variations the first and/or second connector comprises a male RJ45 connector. The first connector may be the same as the second connector, or it may be different. In some variations the connector is configured to support 10/100/1000 BaseT operation.

Any appropriate transceiver may be used for the first and/or second transducer. In general the first and/or second transceiver may be configured to convert electrical signals (e.g., carried by copper wire) into optical signals and optical signals (e.g., carried by fiber optic) into electrical signals. For example the transceiver may be a small form-factor pluggable (SFP) component; an SFP component may be a compact, hot-pluggable transceiver SFP socket port. Any appropriate SFP configuration may be used, for example, the first transceiver may be configured to couple with a single-mode optical fiber, a multi-mode optical fiber, a dual-mode optical fiber, or the like. For example, the first and second transceiver configured as single fiber bi-directional transceivers. The first and/or second transceivers may be matched to the optical fiber used and/or the length of the cabling. The first and second transceivers may be the same, or they may be different. In some variations, the first and second transceivers are configured to support 100Base-FX and 1000-X optical fiber modules.

In general, the cabling between the first and second ends of a fiber optic power over Ethernet (PoE) cable (e.g., where each end typically includes a PoE capable connector and transceiver) may be of any appropriate length, from a meter to thousands of meters. The cabling is typically integrated with the first and second ends, and includes a unitary outer jacket that surrounds the internal optical fiber(s) and adjacent power line(s). The outer jacket may be water and/or weather proof. In some variations the outer jacket surrounds a power line comprising a pair of electrical conductors. Power supplied by the cable may be sent over the pair of electrical conductors. The cables described herein may be adapted to provide any appropriate level of power (PoE), including standard PoE levels (e.g., 15.4 W of DC power, at a minimum 44 V DC and 350 mA, with 12.95 W assured to be available at the powered device for standard PoE power; up to 25.5 W of power for PoE+ devices, or up to 51 W of power, etc.). For example, the apparatuses (cables, adapters, etc.) described herein may support 24V and 48V passive PoE.

The cabling may be referred to as hybrid fiber cabling because it includes both optical (e.g., optical fiber(s)) and electrical power (e.g., one or more copper power lines) in a single housing. Any appropriate configuration may be used, and any appropriate optical fiber and power line(s) may be used. For example, in some variations the optical fiber comprises a bend-insensitive single-mode fiber, such as ITU-T G.657 standard optical fiber.

For example, a hybrid fiber cabling may include a power line comprising a pair of insulated electrical conductors, an optical fiber, and a waterproof barrier surrounded by the outer jacket. The optical fiber(s) and power line(s) may be arranged in any appropriate manner in the cabling. For example, the optical fiber may extend the length of the cabling adjacent to or surrounded by the run through the center of the cabling and be coaxially surround by the power line(s).

Any appropriate PoE power lines may be used. For example, the power line may comprise twisted or untwisted, shielded copper wires for carrying the power. Where multiple power lines are used, each may be separately insulated and/or shielded.

For example, any of the fiber optic power over Ethernet (PoE) cable to both provide power and optically communicate signals between devices described herein may include: an elongate length of hybrid fiber cabling having an outer jacket surrounding both an optical fiber extending the length of the hybrid fiber cabling and an electrically conductive power line extending the length of the hybrid fiber cabling; a first power connector configured to transmit DC power that is coupled to a first end of the electrically conductive power line; a second power connector configured to transmit DC power that is coupled to a second end of the electrically conductive power line; a first optical data connector configured to connect to a first transceiver that converts electrical signals into optical signals and optical signal into electrical signals, wherein the first optical data connector is coupled to a first end of the optical fiber; and a second optical data connector coupled to a second end of the optical fiber and configured to connect to a second transceiver that converts optical signals from the optical fiber into electrical signals and converts electrical signals into optical signals for transmission on the optical fiber.

A fiber optic power over Ethernet (PoE) cable that provides both power and optical transmission of data to a device may include: an elongate length of hybrid fiber cable comprising an outer jacket surrounding an optical fiber extending the length of the hybrid fiber cable, and a power line comprising an electrical conductor extending the length of the hybrid fiber cable; a first power connector connected to a first end of the power line and configured to transmit DC power; a second power connector connected to a second end of the power line and configured to transmit DC power; a first transceiver connected to a first end of the optical fiber through and configured to convert electrical signals into optical signals for transmission on the optical fiber and to convert optical signals from the optical fiber into electrical signals; and a second transceiver connected to a second end of the optical fiber and configured to convert electrical signals into optical signals for transmission on the optical fiber and to convert optical signals from the optical fiber into electrical signals.

The first transducer may be connected to a first end of the optical fiber through a first optical data connector, and the second transducer may be connected to the second end of the optical fiber through a second optical data connector. Any of the hybrid cables described herein may include one or more transducer (e.g., SFP module) for converting electrical signals into optical signals; in some variations the transducer is included as part of the extender (e.g., media converter) to which the cable and/or the Ethernet device may connect.

For example, a cable may include first transceiver, wherein the first transceiver is coupled to the first optical data connector and converts between electrical and optical signals. The cable may also include a second transceiver wherein the second transceiver is coupled to the second optical data connector and converts between electrical and optical signals.

The connectors for the cable (and/or included within an extender) may be RJ45 connector (male/female). For example, a connector of a hybrid cable may be an RJ45 connector that is coupled to the first optical data connector and the first power connector. The connector may be a male RJ45 connector that is coupled to the first optical data connector and the first power connector.

Any of the connectors may be configured to support 10/100/1000 BaseT operation.

As mentioned above, the optical fiber in the cable may be any appropriate optical fiber, including (but not limited to) a single-mode optical fiber. The optical fiber may be break-resistant. The first and second transceivers may be configured as single fiber bi-directional transceivers. The first and second transceivers may be configured to support 100Base-FX and 1000-X optical fiber modules.

Any of the hybrid cables may include a second electrically conductive power line within the outer jacket and coupled to the first power connector, as described above (e.g., “hot” and “ground” or return lines).

In general, the cabling and enclosures (e.g., extenders/media converters) may be adapted for use outside. For example, the hybrid fiber cabling may include a waterproof barrier surrounded by the outer jacket. Similarly the housing of an extender/media converter may be adapted to be weatherproof, including a sealing/sealable enclosure for the connectors and components of the extender/media converter.

Also generally, and of the apparatuses (cables, devices, systems) described herein may be adapted to sense and present the speed of data transmission. For example, any of the cables described may include an output indicating the speed of the transducer. As described in more detail below, the rate/speed of data (e.g., data transfer/conversion between electrical and optical) may be auto-detected (e.g., detecting 100 Mbps, 1000 Mbps, etc.). In some variations the transducer (e.g., SFP module) is configured to automatically detect the rate (speed rate); the detected rate may be presented (displayed, transmitted, indicated, etc.).

Also described herein are methods of powering a device (e.g., an Ethernet device) and providing an optical data connection with a fiber optic power over Ethernet cable. In general, these methods simultaneously provide both power and data to a remotely located (e.g., up to many miles) device. The method may include running a single (integrated) cable having both one or more optical fiber(s) and one or more power line(s) between a PoE switch device (e.g., a data source with power or power injector) and a PoE device (e.g., PoE Ethernet device). Each end of the cable between the hybrid cabling includes a connector coupled to a transceiver for converting electrical signals into and out of the connector(s) into optical signals for transmission along the optical fiber. Power is provided from the connector and down the power line(s).

For example, in one method of powering a device (e.g., Ethernet device) and providing an optical data connection with a fiber optic power over Ethernet cable, the method comprising: connecting a fiber optic power over Ethernet cable to a power over Ethernet (PoE) switch so that a first connector of the fiber optic power over Ethernet cable receives power from the switch; converting electrical signals received by the first connector to optical signals using a first transceiver portion of the fiber optic power over Ethernet cable; transmitting the optical signals through an optical fiber within the fiber optic power over Ethernet cable; powering an Ethernet device connected to the fiber optic power over Ethernet cable from a power line within the fiber optic power over Ethernet cable; and converting the optical signals back into electrical signals using a second transceiver near the opposite end of the fiber optic power over Ethernet cable.

In general, any appropriate device may be connected and powered by the methods and devices described herein. For example, the device may be an Ethernet device such as an antenna.

Any of the methods described herein may be or may include a method of optically transmitting and providing power to an Ethernet device and from an Ethernet data source using a hybrid fiber optic and power over Ethernet cable. For example a method may include: receiving electrically transmitted data from the Ethernet data source; optically transmitting the electrically transmitted data from a first end of the hybrid fiber optic and power over Ethernet cable to a second end of the hybrid fiber optic and power over Ethernet cable; electrically transmitting the optically transmitted data from the second end of the hybrid fiber optic and power over Ethernet cable to the Ethernet device; transmitting DC power from the first end of the hybrid fiber optic and power over Ethernet cable to the second end of the hybrid fiber optic and power over Ethernet cable; and powering the Ethernet device from the DC power transmitted through the hybrid fiber optic and power over Ethernet cable.

A method may be configured as methods of optically transmitting and providing power to an Ethernet device and from an Ethernet data source using a hybrid fiber optic and power over Ethernet cable, the method including: electrically transmitting data from the Ethernet data source to a first end of the hybrid fiber optic and power over Ethernet cable; transmitting DC power from the first end of the hybrid fiber optic and power over Ethernet cable to a second end of the hybrid fiber optic and power over Ethernet cable; converting the data for optical transmission and optically transmitting the data through the hybrid fiber optic and power over Ethernet cable; converting the data for electrical transmission and electrically transmitting the data from the second end of the hybrid fiber optic and power over Ethernet cable to the Ethernet device; and powering the Ethernet device from the DC power transmitted through the hybrid fiber optic and power over Ethernet cable.

Any of the methods described may include connecting the Ethernet device to the first end of the hybrid fiber optic and power over Ethernet cable using a power over Ethernet (PoE) cable, and/or connecting the Ethernet device to the first end of the hybrid fiber optic and power over Ethernet cable though a first media converter. The methods may also include connecting the Ethernet data source to the second end of the hybrid fiber optic and power over Ethernet cable using a second Ethernet cable, and/or connecting the Ethernet data source to the second end of the hybrid fiber optic and power over Ethernet cable using a second media converter.

These methods may also include providing DC power to the hybrid fiber optic and power over Ethernet cable from the Ethernet data source.

The apparatuses and methods described herein may be generally useful for any Ethernet data source, including for example, a switch (e.g., PoE switch), a router, etc. In addition, any of these apparatuses and methods may be generally used and useful with any Ethernet device, including PoE Ethernet devices, for example, the Ethernet device may be an antenna.

Optically transmitting the data through the hybrid fiber optic and power over Ethernet cable may include optically transmitting though a hybrid fiber optic and power over Ethernet cable that is extends outdoors. In general, the DC power may be transmitted by the hybrid fiber optic and power over Ethernet cable concurrently with optically transmitting the data through the hybrid fiber optic and power over Ethernet cable.

As mentioned above, any of these methods may include detecting the speed rate of the transmission of data and/or displaying, presenting, or otherwise indicating this rate (e.g., the speed rate of the transmission of data).

Also described herein are extenders for forming an optical connector between to devices, e.g., two Ethernet devices, where at least one of the devices is powered by a PoE connection. An extender may also be referred to as a media converter, as it may convert the data from electrical to optical transmission over a portion of the distance to the Ethernet device. For example, an extender device for connecting a Power over Ethernet (PoE) device to a remote device using an optical fiber may include: a first connector having a power contact configured to transmit DC power and one or more data contacts configured to carry electrical signals; a transceiver connected to the one or more data contacts of the first connector and configured to convert electrical signals from the one or more data contacts into optical signals and to convert optical signals into electrical signals to the one or more data contacts; and a housing surrounding the first connector and the transceiver.

An extender may also include a second connector having a power contact configured to transmit DC power. In some variations, the extender includes an interface surface on the housing configured to couple to a power over Ethernet (PoE) adapter so that the second connector connects to the PoE adapter. The device may also include an optical fiber connector for connecting an optical fiber to the transducer.

In some variations the extender includes an integrated PoE injector/adapter. For example, the device may include a DC power source within the housing that is configured to receive AC power and provide DC power to the power contact of the connector.

As mentioned above, any of the connectors previously described may be used with the extenders described herein. For example, the connector may comprise an RJ45 connector, such as a male or female RJ45 connector. The connector may be configured to support 10/100/1000 BaseT operation. Similarly, any appropriate transceiver may be used, including any of these described herein. For example, the transceiver may be configured to couple with a single-mode optical fiber. In some variations, the transceiver is configured as single fiber bi-directional transceiver. The transceiver may be configured to support 100Base-FX and 1000-X optical fiber modules.

In some variations the extender device for connecting a Power over Ethernet (PoE) device to a remote device using an optical fiber includes: a first connector having a power contact configured to transmit DC power and one or more data contacts configured to carry electrical signals; a transceiver connected to the one or more data contacts of the first connector and configured to convert electrical signals from the one or more data contacts into optical signals and to convert optical signals into electrical signals to the one or more data contacts; a second connector having a power contact configured to transmit DC power; a housing at least partially enclosing the first and second connectors and the transceiver; and an interface surface on the housing configured to couple to a power over Ethernet (PoE) adapter so that the second connector connects to the PoE adapter.

In general, the interface surface may include a seal to seal the connection between the housing and the interface surface.

Also described are extenders for connecting a Power over Ethernet (PoE) device to a remote device using an optical fiber that include: a connector having a power contact configured to transmit DC power and one or more data contacts configured to carry electrical signals; a transceiver connected to the one or more data contacts of the first connector and configured to convert electrical signals from the one or more data contacts into optical signals and to convert optical signals into electrical signals to the one or more data contacts; an optical connector coupled to the transceiver to connect to an optical fiber; a DC power source configured to receive AC power and provide DC power to the power contact of the connector; and a housing enclosing the transceiver and DC power source.

Also described herein are methods of optically connecting two Ethernet devices wherein at least one of the device is adapted for power over Ethernet (PoE), the method comprising: powering a first device by transmitting DC power to the first device from a connector of an extender, wherein the extender comprises a housing at least partially surrounding the connector and a transceiver; converting electrical signals from the connector into optical signals and using the transducer; transmitting the optical signals along an optical fiber connected to the transducer of the extender to a transducer of a second extender; converting the optical signals from the optical fiber into transmitted electrical signals using the transducer of the second extender; and transmitting the transmitted electrical signals to a second device connected to a connector of the second extender.

Alternatively or additionally, any of the extender devices for connecting a Power over Ethernet (PoE) device to a remote device using a hybrid fiber optic and power over Ethernet cable may include: a first Ethernet connector having a first power contact configured to transmit DC power and a first data contact configured to carry electrical signals; a second power contact configured to transmit DC power; a second data contact configured to connect to a transceiver to convert electrical signals from the second data contact into optical signals and to convert optical signals into electrical signals to the one or more data contacts; and a housing surrounding the first connector and the transceiver.

An extender device for connecting a Power over Ethernet (PoE) device to a remote device using a hybrid fiber optic and power over Ethernet cable may include: a first connector having a first power contact configured to transmit DC power and a data contact configured to carry electrical signals; a second data contact; a transceiver connected to the second data contact and configured to convert electrical signals from the second data contact into optical signals for transmission on an optical fiber, and to convert optical signals from an optical fiber into electrical signals to be transmitted by the second data contact; a second power contact electrically connected to the first power contact and configured to transmit DC power; and a housing at least partially enclosing the first connector and the transceiver.

As mentioned, in general, the transceiver may be included as part of the extender, e.g., connected to the second data contact, wherein the transceiver is configured to couple to an optical fiber. Any of these devices may also include an optical fiber connector for connecting an optical fiber to the transducer.

The housing of any of these devices may form a weatherproof enclosure surrounding the first connector and the transceiver.

In some variations, the extender devices include a DC power source within the housing that is coupled to the second power contact and configured to receive AC power and provide DC power to the power contact of the connector. Alternatively, the DC power may be supplied through the extender from the PoE connection (e.g., from the data source).

Any of the connectors of the extender may be an RJ45 connector, for example, the first connector may be a male RJ45 connector. The first connector may be configured to support 10/100/1000 BaseT operation. In general, the transceiver may be configured as single fiber bi-directional transceiver.

Any of the devices (e.g., extenders) may include an output indicating the speed of the transducer and/or data transmission through the extender. The speed though the hybrid cable and/or extender may be displayed or presented on an outer surface of the device. For example, the rate may be displayed by an LED indicator on the outer surface.

### BRIEF DESCRIPTION OF THE DRAWINGS

FIG. 1A is a schematic overview of one variation of a hybrid optical/electrical cable as described herein.

FIG. 1B illustrates one example of a hybrid optical/electrical cabling system.

FIG. 1C schematically illustrates an extender portion of an optical fiber/electrical power cabling system.

FIG. 2 illustrates another example of a hybrid optical/electrical cable.

FIGS. 3A, 3B and 3C illustrate exemplary components that may be used to form a hybrid optical/electrical cable as described.

FIG. 4A illustrates one variation of a hybrid fiber cabling.

FIG. 4B shows another example of hybrid fiber cabling.

FIG. 5 shows another variation of a system including two hybrid connectors and a hybrid cabling between the two.

FIG. 6 is a schematic description of one variation of an extender for optically extending the electrical connection between two (or more) devices including PoE devices.

FIG. 7A illustrates the connection of one extender and a PoE adapter.

FIG. 7B shows an extender (configured for indoor use) and a PoE adapter that is configured to provide 80V (e.g., at 1.2 A), and power up to 60 W.

FIGS. 7C and 7D illustrate the connection of the extender and PoE adapter of FIG. 7B.

FIG. 8A shows one variation of a system including two PoE extenders connected by an optical fiber cabling.

FIGS. 8B, 8C and 8D illustrate variation of the extenders which may be used as part of a system such as the one shown in FIG. 8A.

FIG. 9A shows a front, right-side view of one variation of an extender including an enclosure. The extender may also be referred to as a hybrid adapter (power over fiber adapter) or media converter. The extender in FIG. 9A is shown without a hybrid optical/power cable or standard PoE cable (Ethernet cable) attached.

FIG. 9B shows a front, right-side view of a variation of the extender such shown in FIG. 9A, with a hybrid optical/power cable attached and an Ethernet cable attached.

FIG. 9C shows a front left-side view of a variation of the extender of FIG. 9A without a hybrid optical/power cable attached, and without an Ethernet cable attached.

FIG. 9D shows a left-side perspective view of a variation of the extender such as the one shown in FIG. 9C, with a hybrid optical/power cable attached and an Ethernet cable attached.

FIGS. 10A, 10B and 10C show top, bottom and side views, respectively, of an extender enclosure similar to the variation shown in FIGS. 9A-9D, above, including a mount region on the back for mounting to a surface (pole, wall, etc.).

FIGS. 11A, 11B and 11C show top, side and end views, respectively of another example of an extender housing including exemplary dimensions.

FIG. 11D shows a sectional view of the extender of FIG. 11A.

FIG. 12A shows a top perspective view of an extender such as the one shown in FIG. 11A-11D with an inner camber open.

FIGS. 12B, 12C and 12D illustrate the extender of FIG. 12A with a hybrid fiber optic and power over Ethernet cable attached, as well as a standard PoE Ethernet cable attached within the open chamber.

FIG. 13A illustrates the extender of FIGS. 12B-12D with the cover closed over the inner chamber.

FIG. 13B shows a sectional view through the extender similar to that shown in FIG. 11D, with the cover open, showing the cover latch.

FIG. 13C shows an enlarged view from FIG. 13B showing the hinge region of the cover and housing of the extender.

FIG. 14 shows a bottom view of an extender, including a mount region that is separated from the housing of the extender by a predetermined amount (e.g., 20 mm) allowing room between the housing and the surface to which the extender is mounted.

FIG. 15A shows a top perspective view of an extender with the cover off, illustrating some of the sealing elements, including a drain structure, adapting it for use in the outdoors.

FIG. 15B shows an enlarged view of the drain structures of FIG. 15A.

FIGS. 16A and 16B illustrate opening of the cover of one variation of an extender device.

FIG. 17 illustrates transducers configured to detect rate of data transmission through the transducer.

FIGS. 18A and 18B illustrate variations of systems including a hybrid fiber optic and power over Ethernet cable connecting two extenders to two different Ethernet devices (antennas).

### DETAILED DESCRIPTION

Described herein are hybrid electrical and optical cables that provide connection to and/or between devices to transmit broadband (e.g. Ethernet) signals and power (e.g., PoE) to and/or between the devices. As used herein the term “cable” or “cabling” may refer to a length (any appropriate length) of material used to connect and transmit information and/or power. For example, described herein are hybrid optical/electrical cables configured to connect to a first device at a first end of the hybrid cable and to a second device at a second end of the hybrid cable. The connection(s) may be custom or via standard (e.g., RJ45 connectors). The hybrid cable may connect to or may include an electrical/optical media converter at each end of the cable run for convert electrical signals (e.g., broadband signals) into optical signals that are transmitted down the length of cable. The hybrid cable also transmits power (e.g., DC power at PoE levels) between along the length of cable. Thus, a hybrid optical/electrical cable as described herein typically includes one or more optical fiber as well as one or more power line (e.g., copper wire(s) for transmission of power). As described herein, the electrical portion required to transport power may be completely de-coupled from the Ethernet signaling (optical) and thus the Ethernet may be protected from ESD failure and electrical noise issues from the outside environment.

Any of the devices and systems described herein may be particularly useful for connecting to an Ethernet device over a substantial distance in the outdoors. For example, the hybrid fiber optic power over Ethernet (PoE) cables described may be used to connect to a remotely located device, such as an antenna (e.g., for wireless communication). These hybrid fiber optic power over Ethernet (PoE) apparatuses (systems and device) may be adapted for use outdoors; for example, the cabling and extenders configured to connect the hybrid fiber optic power over Ethernet (PoE) cable to the devices at either end (e.g., router, antennas, etc.) may be weatherproof and may include water and/or temperature handling features such as coatings, drains, etc. These apparatuses described herein may be used to connect to devices that are up to 30 km (e.g., 25 km, 20 km, 18 km, etc., and generally >1 km) away, providing both DC power and optical transmission of data over this length.

In general, when a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

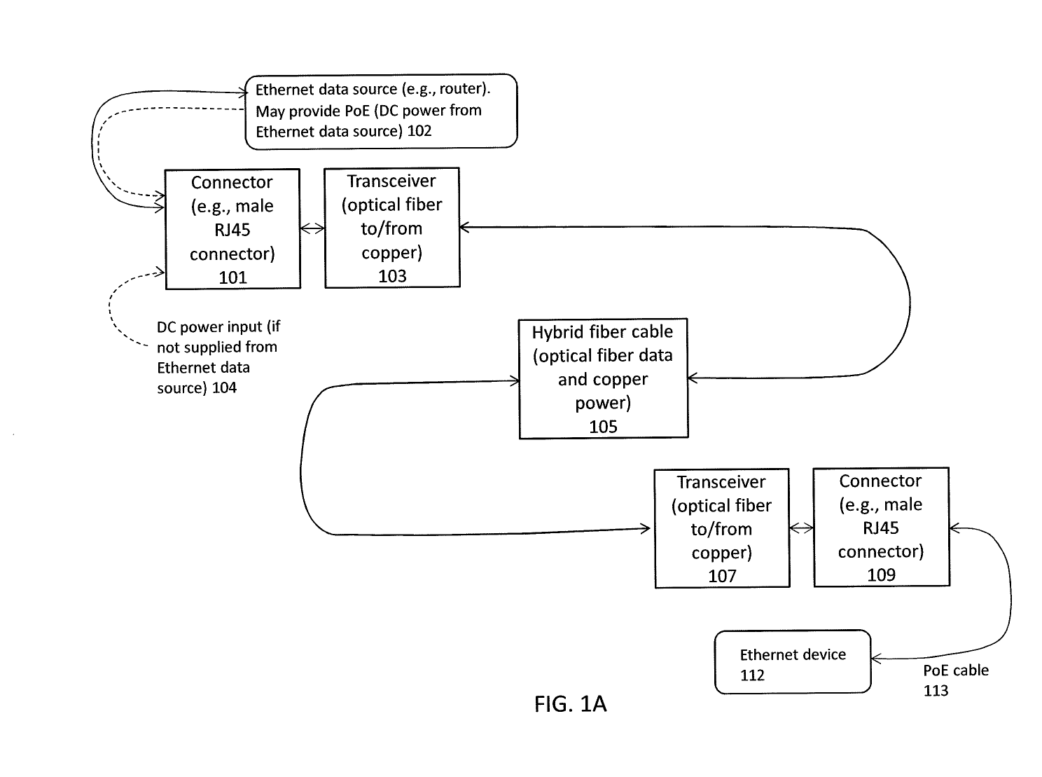

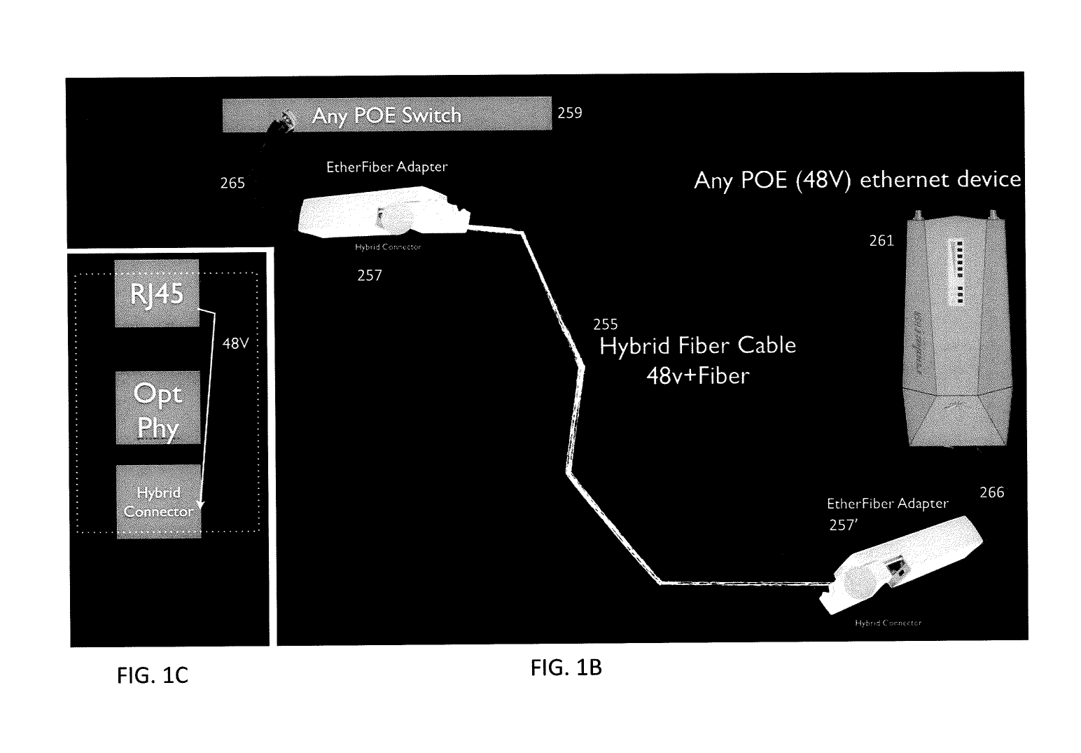

FIG. 1A shows a schematic illustration of a fiber optic power over Ethernet (PoE) cable. In this example the cable includes a first connector 101, a first transceiver 103 for converting between electrical and optical signals, an elongate length of hybrid optical and electrical cabling 105, a second transceiver 107 for converting between electrical and optical signals, and a second connector 109. In operation, the hybrid cable may be connected at a first end to a data source 102 (e.g., Ethernet data source such as a switch, including PoE switches, a power injector for PoE, a router, etc.), and a second end may be connected to a PoE (Ethernet) device 112 such as an antenna, camera, etc. by a standard PoE cable 113. If the data source does not provide PoE, a separate source of DC power may be provided 104.

The cable, transceivers and connectors to the devices at either end may be integrated into a single apparatus, or modular elements may be combined to form the hybrid connection. For example, the hybrid optical/power over Ethernet apparatus may be integrated so that a first end includes a first connector and transceiver integrated with a hybrid optical/electrical cabling and the second end includes a second connector and transceiver integrated with the opposite end of the cabling. This integration allows the components to be matched and/or tuned to optimize their operation. Alternatively or additionally the apparatus may include an extender, or multiple extenders, which may be configured as a media converter, and hybrid cabling that extends between the extenders. The extender may be a separate device that includes an integrated transceiver or that is adapted to hold a transceiver that is connected to the optical fiber of the hybrid cabling; the extender may also include a connector to connect to a “standard” Ethernet cable, including standard PoE cables, which can connect to the devices (e.g., routers, antennas, cameras, etc.). In some variations, the apparatus is adapted to be manually adjusted, for example, by the party connecting the devices; thus a hybrid cabling may be cut to a desired length, an optical connector attached to one or both ends of the optical fiber portion of the cable and/or it may be directly connected to a transceiver to convert data between optical and electrical, and the electrical and optical portions of the hybrid cabling may be connected to an extender and/or directly connected to a standard connector such as an RJ45 connector for connecting to a device.

As mentioned briefly above, any appropriate connector may be used for the first and second connectors. For example, the first and/or second connectors may be RJ45 connectors.

An RJ45 connector, in the context of Ethernet and category 5 cables, may refer to a registered jack (RJ) standard having a specific mechanical interface and wiring scheme. Similar connectors includes 8P8C modular plugs and jacks that look very similar to the plugs and jacks used for FCC's registered jack RJ45 variants, although the RJ45S may not be compatible with 8P8C modular connectors. Standard un-keyed modular connectors are often used for computer networking, and informally inherited the name RJ45. While RJ45S uses a keyed variety of the 8P body, meaning it may have an extra tab that a common modular connector is unable to mate with. Thus, as used herein, RJ45 may also refer to 8P8C, un-keyed modular connectors with Ethernet-type wiring contact-outs. In common usage, RJ45 may also refer to the contact assignments for the attached cable, which are actually defined as T568A and T568B in wiring standards such as TIA/EIA-568-B. Other types of connectors include the 10P10C connector is commonly referred to as an RJ50 connector.

The optical fibers described herein, including the optical fibers forming part of the hybrid cables, may be any appropriate optical fiber, including simplex, duplex, or multiplex (e.g., bundles of optical fibers). Thus, any of the optical fibers described may have simplex, duplex or multiple optical fiber cores forming the optical fiber.

Any appropriate transceiver may be used for converting between electrical signals (e.g., carried on an electrical conductor such as copper wire and received by the connectors) and optical signals (e.g., carried by the fiber optics). For example, the transceiver may be a small form-factor pluggable (SFP) type transceiver. Any appropriate type of SFP transceivers may be used, typically matched to the optical fiber within the cabling and/or the length of the cabling, to provide the required optical reach over the available optical fiber type (e.g. multi-mode fiber or single-mode fiber). Any appropriate SFP module may be used, for example, 100BASE-BX10, 100BASE-FX, 100BASE-LX10, 1000BASE-BX, 10000BASE-LX, 1000BASE-LX10, 1000BASE-SX, single-mode fiber, multi-mode fiber, with simplex fiber cable, duplex fiber cable. Examples of optical SFP module categories include, for multi-mode fibers, SX—850 nm, for a maximum of 550 m at 1.25 Gbit/s (Gigabit Ethernet) or 150 m at 4.25 Gbit/s (Fiber Channel). For single-mode fibers, LX—1310 nm, for distances up to 10 km, BX—1490 nm/1310 nm. For single fiber Bi-Directional Gigabit SFP Transceivers, paired as BS-U and BS-D for Uplink and Downlink respectively, for distances up to 10 km. Variations of bidirectional SFPs may also use 1550 nm in one direction. SFPs may also be compatible with 1550 nm 40 km (XD), 80 km (ZX), 120 km (EX or EZX) variations. Some SFPs may be configured for CWDM and DWDM transceivers at various wavelengths achieving various maximum distances. For copper twisted pair cabling, the SFP may be configured for 1000BASE-T and can be used for Gigabit Ethernet.

Another variation of SFP is SFP+, an enhanced small form-factor pluggable that is an enhanced version of the SFP that supports data rates up to 10 Gbit/s. SFP+ supports 8 Gbit/s Fiber Channel, 10 Gigabit Ethernet and Optical Transport Network standard OTU2.

In some variations the apparatus is adapted so that the rate of transmission (e.g., though the transceiver converting between optical and electrical signals) is monitoring and/or selected. For example, a transceiver may be adapted to detect the general/overall rate of transmission (e.g., 100 Mbps, 1000 Mbps, etc.). Thus, any of the apparatuses described herein may be adapted to detect (e.g., monitor) the rate of transmission, and may include an output or indicator for the rate of transmission.

FIG. 1B illustrates one example of a fiber optic power over Ethernet (PoE) cable 255. In this variation the first end is connectable to any PoE switch 259. The first and second ends include or can be connected to extenders 257, 257′ (also referred to as hybrid connectors, EtherFiber adapters or media converters). In this example, the extenders each house a connector to connect to a standard or PoE Ethernet cable and the transceiver connected or connectable to an end of the hybrid optical/power cable 255. The hybrid cabling 255 includes a fiber optic line and one or more power line(s) that each connect at the two ends. The power line(s) running within the hybrid cabling carry DC voltage to power the Ethernet device 261 at one end; in this example, the power lines are adapted to carry 48V. In FIG. 1B the hybrid cable connects to a PoE Ethernet device (shown here as an antenna) through a standard PoE cable 266 and the data source (e.g., router) may be connected at the other end by a standard Ethernet cable 265; if the data source does not provide power (PoE) through the Ethernet cable 265, a separate or additional power source may be connected or included as part of the hybrid connector 257 at that end of the apparatus. The hybrid connectors may be integrated into the overall cable, forming a unitary apparatus. FIG. 1C schematically illustrates the Ethernet adapter, including an RJ45 connector adapted to connected to an optical fiber and a power cable.

FIG. 2 illustrates one example of an integrated cable including elements illustrated in FIG. 1A. In this example, the cable provides conversion between copper (electrical signals) to optical (optical fiber signals) for Ethernet signals. The cable integrates, at both ends, an SFP socket port, which can support 100Base-FX, 1000-X optical fiber modules, with an RJ45 connector. The RJ45 connector is a male RJ45 connector that supports 10/100/1000Base-T/TX copper port and IEEE 802.3af/at PoE features. The cable may use the power contacts of the connector to deliver electrical power to remote device, or receiver electrical power from any PSE devices by connecting through the body of the cable to one or more power lines. Thus, one electrical power connector may deliver electrical power to a link partner or pass through electrical power using the RJ45.

In this example, only one hybrid fiber cable, which includes copper wires to deliver electrical power, and optical fiber(s) to carry Ethernet signals, extends between two “adapters” (e.g., the connector and transceiver at both ends) that are integrated into the cable ends; a separate “extender” is not needed and the male connectors 227 (e.g., RJ45 connectors) may connect at one end to a data/power source, providing both electrically encoded data as well as DC power, and at the other end to an Ethernet device that can receive PoE from the cable. Between the ends data is transmitted optically along an internal optical fiber; each end 221 include a transceiver that converts between electrical signals input/output from the hybrid cable and optical signals transmitted along the cable 225.

As discussed above, the hybrid optical/PoE cables described herein can prevents ESD, EMI, and may allow coverage of long transmission range, (e.g., >2 km), without significant signal degradation, depending in part on the SFP optical module.

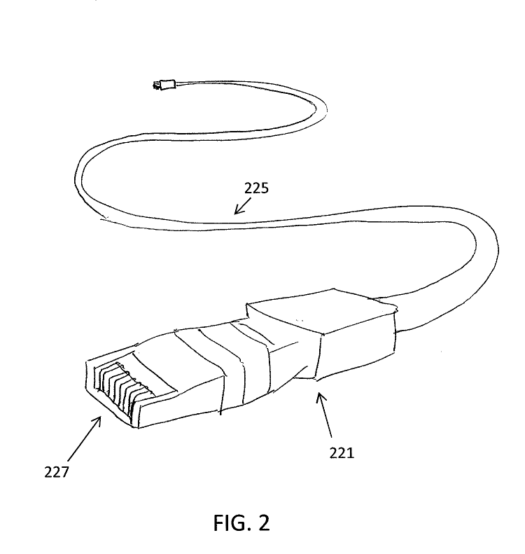

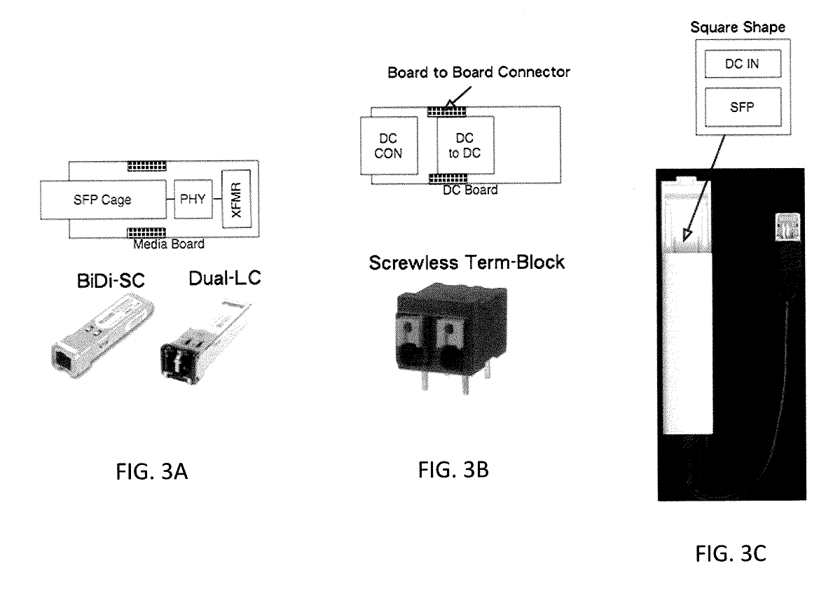

FIGS. 3A-3C illustrate exemplary components that may be integrated (or whose function may be integrated) in to the fiber optic power over Ethernet (PoE) cables described herein. For example, FIG. 3A illustrates two types of SFPs (BiDi-SC and Dual-LC) that may be used as transducers, or adapted for use, along with an exemplary schematic. In FIG. 3B, power connectors for linking the power line(s) to provide power over the cable are illustrated schematically and as an in exemplary screwless term-block. FIG. 3C illustrates a housing (adapter) that may hold a transducer (e.g., SFP) and a connector such as a PoE connector that may be connected at one end to a device and at the other end to a hybrid cable.

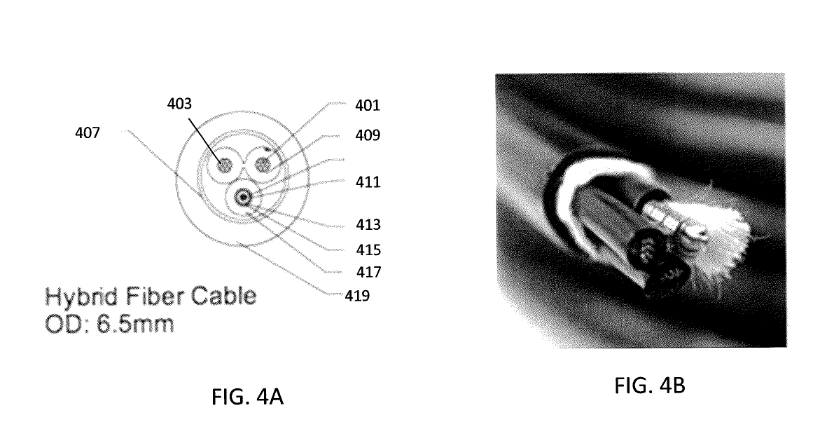

FIGS. 4A and 4B illustrate an example of hybrid cabling that may be used between two adapters as discussed above. In this example, the hybrid cable shown has an outer diameter of approximately 6.5 mm. In the schematic of FIG. 4A, the cabling includes a pair of copper wire electrical power lines 401, 403 that are each insulated 409. In addition, the cabling includes an optical fiber 405. The optical fiber and electrical power lines are all surrounded by a waterproofing layer (waterproof tape 407), and then by shielding and an outer jacket 419. Additional layers of shielding, water- and weather-proofing may be included around the individual optical fibers and electrical power lines, as well as collectively around all of them, including, for example around the optical fiber, buffer material 411, steel armature 413, Kevlar yarn 415, and one or more inner jackets 417. FIG. 4B illustrates another variation of a portion of hybrid fiber cabling.

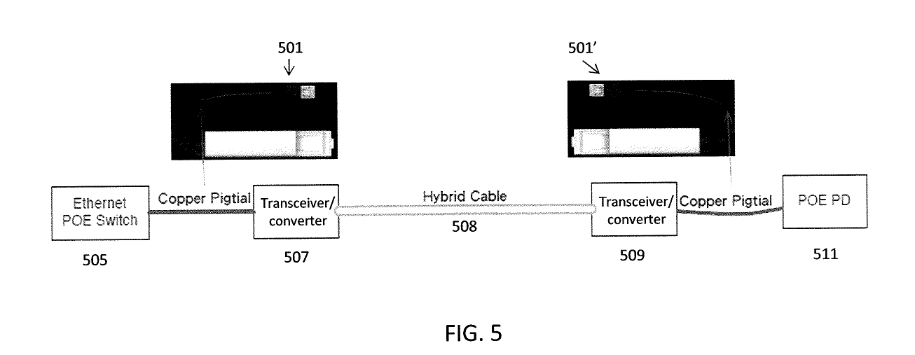

In some variations one or more hybrid connector (e.g., extenders, EtherFiber adapters, etc.) may be used with a hybrid cable that does not include an integrated PoE competent connector and transceiver at one or both ends. For example, two extenders 501, 501′ may be connected to a hybrid cable as shown in FIG. 5. The hybrid cable may be separately connectable to the hybrid connectors. In some variations the connector is configured to attach/couple with the transceiver to form the hybrid connector; in some variations these two components are integrated together. For example, the hybrid connector may be a unitary apparatus including a connector and the Etherfiber transceiver forming a unitary connector so that the two cannot be separated from each other without disassembling the hybrid connector. An outer housing may enclose at least a portion of the transceiver and the connector (or at least the connection between the two). As described above, in some variations the apparatus includes a unitary combination of two hybrid connectors connected by a hybrid cable; alternatively one end may include an integrated extender/hybrid connector, while the other side may be separately connectable.

In FIG. 5, the extender 501 includes a connector connecting to the data source and source of DC voltage (e.g., an Ethernet POE Switch 505). An electrical/optical transceiver 507 that converts between the data between optical and electrical transmission formats (transceiver converter”) is connected so that data signals and power are passed to and from the connector, and the data signal(s) are passed to and from the transceiver/converter 507 and converted to optical signals for optical transmission on a hybrid cable and optical data received by the transceiver/converter 507 is converted to an electrical signal sent to the switch 505. The power is passed to and/or from the power line(s) in the hybrid cable. Both ends of the hybrid cable 508 include hybrid connectors (e.g., 501, 501′).

### Extenders

As mentioned, any of the hybrid cables described herein may be attached at either end to an extenders (hybrid adapter). As mentioned, an extender and hybrid cable (fiber optic power over Ethernet (PoE) cables described above) may be used to extend connections between devices beyond the reach of ordinary (e.g., CAT-5) cables with low electrical interference by transmitting signals optically, where the extenders provide a simple and convenient way to connect between standard cabling (e.g. copper wire cabling) and the hybrid (optical) cabling described.

An extender may be configured to interface with (or incorporate) a Power over Ethernet (PoE) adapter/injector. An extender may be also referred to as a fiber optic power over Ethernet (PoE) extender.

An extender may include a transceiver (SFP) configured to convert between electrical signals and optical signals for receiving/transmitting along an optical fiber (e.g., optical fiber cable), one or more connector (e.g., an RJ45 connector, male, female or male and female). The connector(s) may be PoE capable connectors that may include one or more power lines configured to connect the RJ45 connector to a source of power or to provide power to a device connected to the connector.

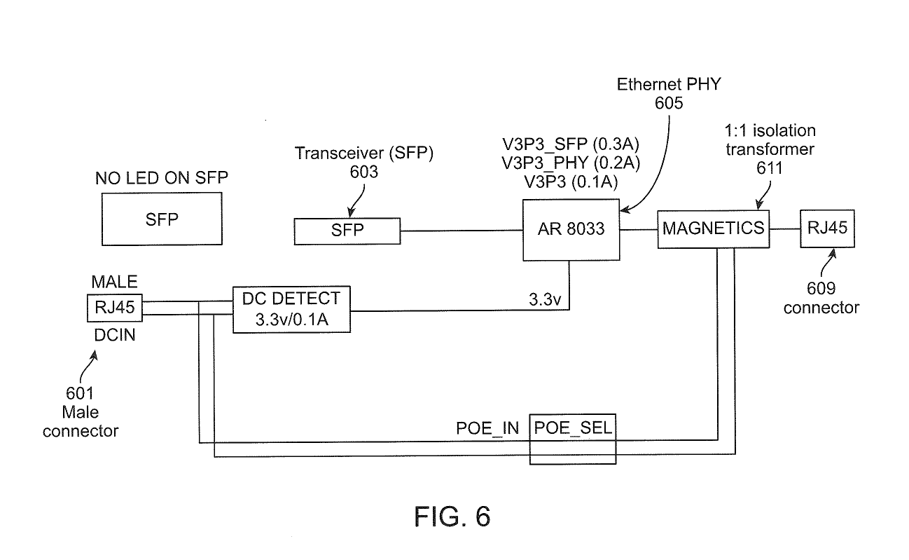

In some variations, an extender may be configured to connect to a PoE adapter/injector, receive/transmit optically (via an optical fiber cable) and connect to a device (e.g., powered device, Ethernet device, switch, etc.). For example, an extender configured to interface with a PoE adapter is illustrated schematically in FIG. 6. In this example, the extender includes a male connector 601, which is a PoE connector (e.g., a RJ45 connector capable of receiving/transmitting power via one or more contacts and data by other contacts). The connector 601 can alternatively or also be a terminal block, DC jack, pin header, or any power connector, which can be connected with power lines from/to hybrid cable directly.

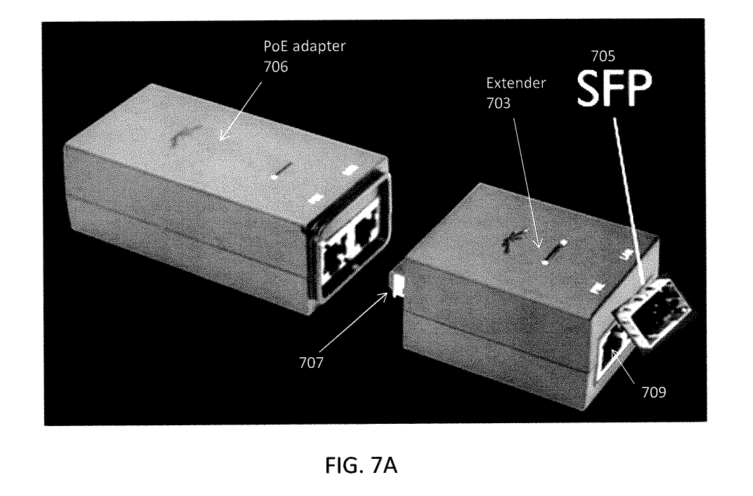

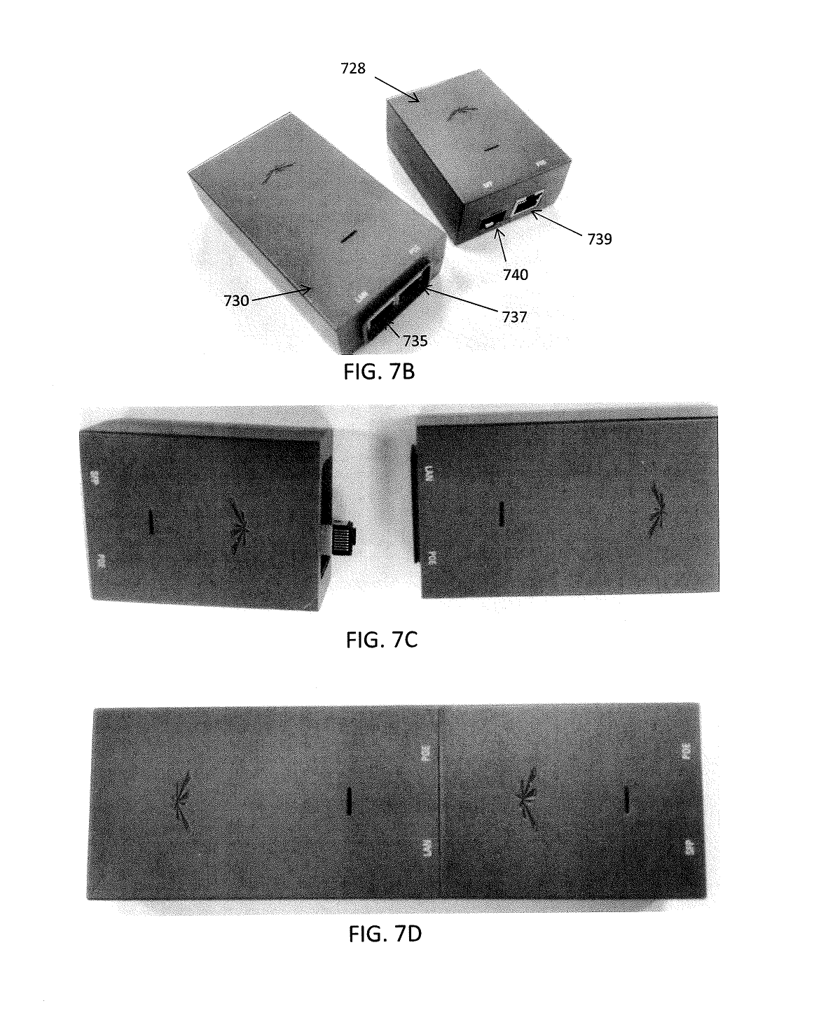

In FIG. 6, the male connector is configured to interface with a PoE adapter (as shown in FIG. 7A). The connector is internally connected to a transceiver (e.g., an SFP transceiver as described above) and provides power (e.g., 3.3V) to internal components of the extender, including, in this example, an Ethernet PHY 605 that is also connected to the transceiver. The extender also includes a second connector 609 that may connect to a device for sending receiving Ethernet signals (e.g., powered device, Ethernet device, switch, etc.). An isolation transformer 611 (e.g., 1:1 isolation transformer) may be connected between the Ethernet PHY 605 and the second connector 609. In some variations the Ethernet PHY includes an integrated isolation transformer. The transceiver may also connect to an optical fiber. In some variations the optical fiber may be integrated with one or two extenders (e.g., as an “extender cable” having an extender at either end), or an optical fiber may be connected or connectable to one or two extenders (e.g., one at either end of the cable).

In the variation shown in FIG. 6, for example, the extender can be connected to a PoE adapter (which may also be referred to as a PoE injector); the first connector 601 may connect into the PoE connector of the PoE adapter. The extender may be configured to mate with or otherwise interlock to the PoE adapter. For example, the extender may be configured to form a water-tight, weather-tight, etc. connection with the PoE adapter. As discussed below, in some variations the extender may include an internal PoE adapter, or may include components providing PoE injection.

FIG. 7A illustrates an extender that may be connected to a PoE adapter as shown. The extender of FIG. 7A, as well as the extenders shown in FIGS. 7B, 7C, and 7D, may be used indoors and may be referred to as “indoor adapters”. In FIG. 7A, the extender includes a transceiver 705 configured to convert between electrical signals and optical signals for receiving/transmitting along an optical fiber (not shown), two PoE competent connectors 707, 709 (e.g., an RJ45 connector), and an interface for connecting to a PoE adapter. This example includes a male connector 707 that forms part of the interface connecting to the PoE adapter 706. Connecting to the PoE adapter 706 may both power the extender and allow the extender to provide power on one or more of the contacts of the second (female) connector. In other variations the interfacing connector 707 maybe female instead of male, and the female connector 709 may be male instead of female; alternatively, both connectors may be male or both female. The interface between the extender and the PoE adapter may be waterproof/water resistant. A seal, gasket, O-ring, etc. may be positioned between the two devices as part of the interface. Thus, the device may be configured for use outside, and resistant to weather (including water).

As mentioned above, the any appropriate connector 705 may be used. For example, the connector 705 could be SFP+ to support 10 Gbps speed rate, 10 GBASE-L\LR\LRM\LW\LX4\S\SR\, etc. The connector 705 could be CXP/CFP/CFP2/CFP4 to support 100 Gbps speed rate.

Any of the extenders described herein may include a second power connector, RJ45, can couple DC power and transmit/receive electrical data signal.

In a first mode, the extender shown in FIG. 6 (and FIGS. 7A-7D and FIGS. 9A-16B) may connect to an Ethernet switch. Data signals from the Ethernet switch may be transmitted by the extender over a hybrid cable (including an optical fiber) that is connected to the extender. In some variations the extender also connects (e.g., interfaces) with a PoE adapter. The PoE adapter may provide power to the extender. In some variations, the extender may receive power as a powered device from the PoE connector without itself connecting to a PoE adapter/injector.

In another mode, an extender such as the one shown in FIGS. 6 and 7 may be connected to a powered device that receives power as well as data from the extender. Any appropriate PoE powered device (e.g., Ethernet device) may be used with the extender. For example, the powered device may be an antenna, a camera, etc. In this mode, the extender may be connected (e.g., interfaced) with a PoE adapter as well as a hybrid cable including an optical fiber. A first connector connects to the PoE adapter, and a second connector connects to the powered device; the second connector transmits power from the PoE adapter and sends/receives data to/from the optical fiber and to/from the powered device using the transceiver. Thus, for example, a second connector (e.g., in FIG. 7A, the female RJ45 connector) may carry electrical power from male RJ45 connector, and Ethernet signal from SFP optical module. In general, the first and second connector can pass through electrical power to each other. In FIG. 7A, the male RJ45 connector can be a pigtail type, easily connected, for common Ethernet device.

FIG. 7B shows an AC to PoE adapter 730 on the left, and indoor extender 728, on the right. The PoE adapter 730 includes an AC input (e.g., for wall power), a LAN (data) input 735, and a PoE output 737 (data and power) and may be adapted to provide nay appropriate level of power (e.g., 24V DC, 44V DC, 48V DC, etc.). The extender 728 (in this example, adapted for indoor use, and thus referred to as an indoor extender) includes a connector (e.g., input/output) for the PoE input 739, e.g., from the output of the power adapter 730 or another source of PoE (power/data). The extender 728 also includes a connector to a hybrid cable (labeled “SFP” to indicate the transducer portion). FIG. 7C shows the indoor extender and power adapter adjacent prior to connection, while FIG. 7D illustrates the two connected, so that power is provided by the power adapter and data is provided by the PoE connector; the hybrid cable may therefore transmit data optically over a fiber optic and, concurrently, DC power over the power line of the hybrid cable. The indoor extender may support multiple PoE power devices (e.g., four pairs), up to, for example, 60 W.

Any of the apparatuses described herein may be adapted for indoor, outdoor or indoor/outdoor operation. Adaptation for outdoor operation may include weatherproofing, or water/moisture management, including drains, seals and the like. Any of the “outdoor” devices may also be used indoors, and the indoor devices may be used outdoors. Any of the hybrid cables described herein may also be flame retardant.

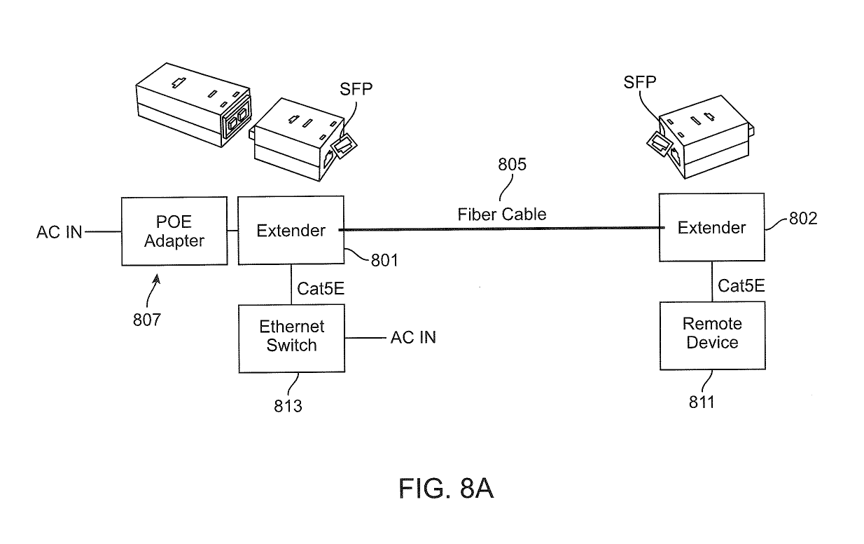

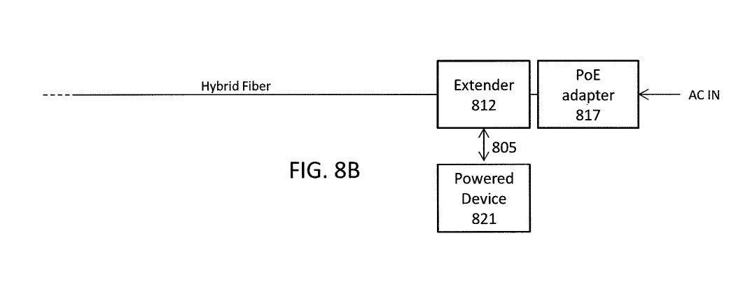

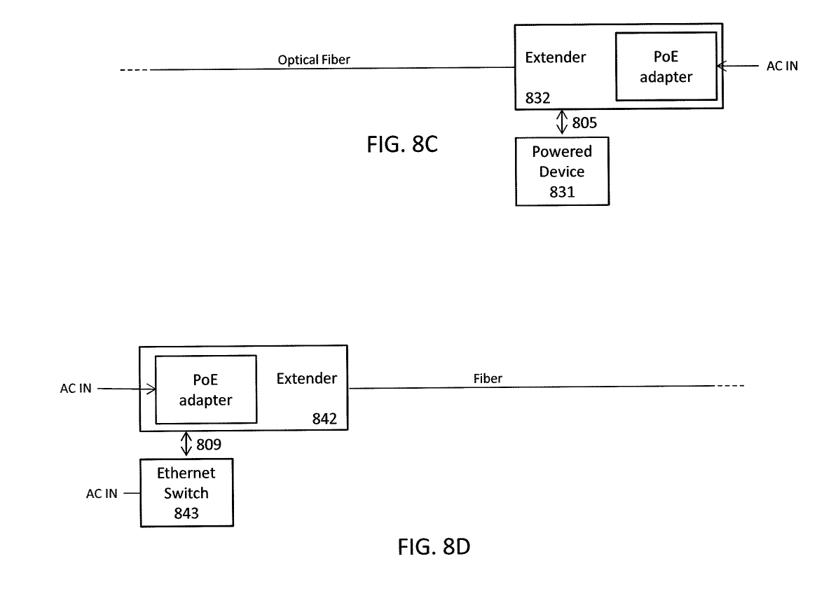

FIGS. 8A-8D illustrate various configurations of extenders, and ways to use them. In general, the extenders described herein may be used to connect (via fiber optic cabling) over very long distances (e.g., more than 2 km or longer). As mentioned above, the run length may depend in part on the transducer (e.g., SFP module). The extenders described herein may be used with the fiber optic power over Ethernet (PoE) cables described above. The first and second connectors may be integrated into an enclosure of the extender (e.g., housing). When two extenders are used (typical configuration), an optical fiber cable may be used; the fiber may be part of a hybrid cable as described above. The fiber cable may carry high speed Ethernet signals between two extenders. As mentioned above, an extender can be plugged into a PoE power adapter directly, and form a waterproof connection between PoE power adapter and extender.

In FIG. 8A, a system including two extenders is illustrated; the two connectors are connected together via a hybrid cable including an optical fiber 805. On the left side of the figure, the first extender 801 is coupled with a PoE adapter 807 that receives AC power (e.g. from a wall line). The extender 801 in this example is also connected to an Ethernet switch 813. In this example the Ethernet switch is powered by AC power (“AC IN”); the power from the PoE adapter may be used to power the extender and may, in some variations be transmitted to the remote device 811 by the hybrid cabling 805. The Ethernet switch 813 may also be powered from the PoE connection of the extender. Data is communicated to and from the switch 813 by the cable 805 through the extender, as discussed above.

On the right side of FIG. 8A, the second extender 802 is shown. The second extender 802 is also connected to the cable 805 and to a remote device 811 (e.g., a powered device). The remote device may receive power from the PoE connector (the “second connector” in FIGS. 6 and 7, above) of the extender 802 through the cable connection (e.g., the CAT-5 cable). Alternatively, in some variations the systems may be used with non-PoE remote device that receive power separately. The remote device 811 may receive electrical signals to/from the cable 805 by way of the extender 802. In some variations a PoE adapter is integrated into the extenders 801, 802, so that it forms a unitary device. In this example, the device does may not need two PoE connectors, and a source of power (e.g., AC wall power). Similarly, in some variations two extenders may be integrated with optical fiber cabling to form a hybrid cable. A hybrid cable may include any of the variations of extenders discussed herein at either end of the cabling, and optical fiber cabling extending between the two. A hybrid cable may be integrated so that the extenders cannot be disconnected from the optical fiber cabling without cutting it apart, or otherwise disassembling it. For example, the cabling and extenders may be covered by a sealed covering (outer covering) that is weatherproofed, or housing.

FIG. 8B illustrates an alternate variation of the right side of the system shown in FIG. 8A, in which the extender 812 provides power to the powered device 821 using an additional PoE adapter 817 connected to the extender. This configuration may allow even greater lengths of hybrid cable to be run without worrying about loss of DC voltage in the line (e.g., >50 km or more).

Any of the extenders described herein may be adapted for use with a cable that includes and optical fiber but does not necessary include one or more power lines. Thus, the hybrid cabling may not be necessary, though it may add the ability to power the device remotely as described above. For example, in FIGS. 8B and 8C a PoE device may be powered by adding the AC in situations where the cabling used in not hybrid cabling that includes both optical fiber and a DC power line. For example, in FIG. 8C the extender also acts a PoE adapter/injector, and incorporates all of the functions of the PoE adapter, as mentioned above. The powered device 831 receives power from the PoE adapter. When the cable used is a hybrid cable including a power line, the PoE adapter portion of the extender may be disabled or redundant (e.g., now AC in need be provided), when there is sufficient power supplied by the power line(s) of the hybrid cabling. As shown in FIG. 8D, the same extender configuration may be used at the local end or the remote end, and the PoE adapter may be used, e.g., provided with power, or not.

In FIG. 8D the extender also includes a PoE adapter (e.g., includes an integrated PoE Adapter as part of the extender), which may provide power to one or more lines of the PoE connector of the extender. In this example, the extender 842 is connected to an Ethernet switch 843 which sends and receives electrical signals via the PoE connector of the extender, but does not use the power supplied by the PoE connector.

Alternatively, in some variations, the extender does not include a PoE adapter portion (or need to connect to a PoE adapter), but as mentioned above, receives the DC power directly from the device (e.g., Ethernet switch 843) it connects to. In variations including an integrated PoE adapter, the extender may detect when DC power is provided by the device directly and may ignore or disable the PoE adapter.

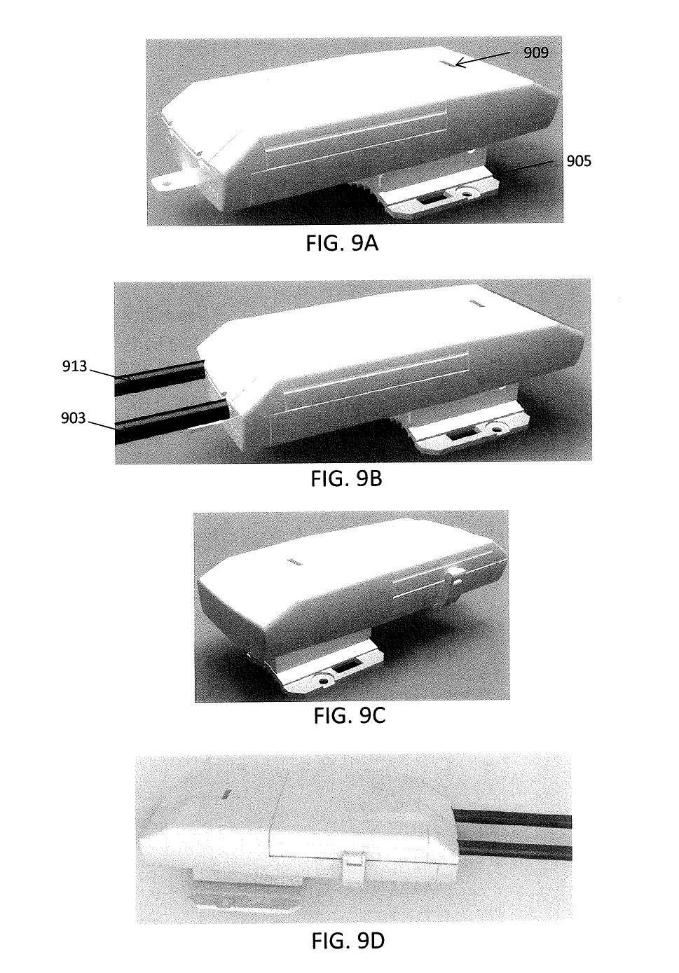

FIGS. 9A-9D illustrate variations of extenders (aka, hybrid adapters or media converters) that may be used as part of the apparatuses described herein to convert electrical signals from a local device (e.g., router, switch, etc.) to optical signals for transmission with DC power over a hybrid fiber optic and power over Ethernet cable. For example, FIG. 9A shows a right perspective view and FIG. 9C shows a left perspective view of an extender that includes an outer housing with an indicator light (e.g., LED) 909 that may be configured when the apparatus is active (e.g., receiving power and/or transmitting data). The housing includes a mount 905 on the back to allow it to be mounted to a surface (e.g., pole, wall, etc.). FIGS. 9B and 9D show the extender of FIGS. 9A and 9C with a hybrid cable 903 and a “standard” PoE cable 913 attached. The PoE Ethernet cable includes both a copper data line (for transmission of electrical signals) and a DC power line.

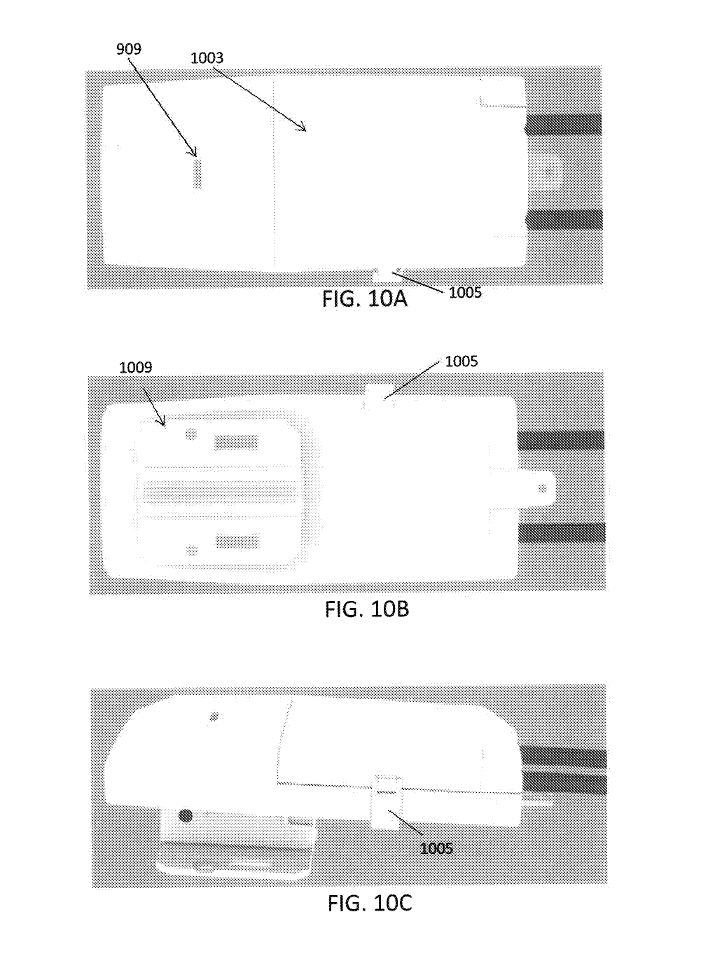

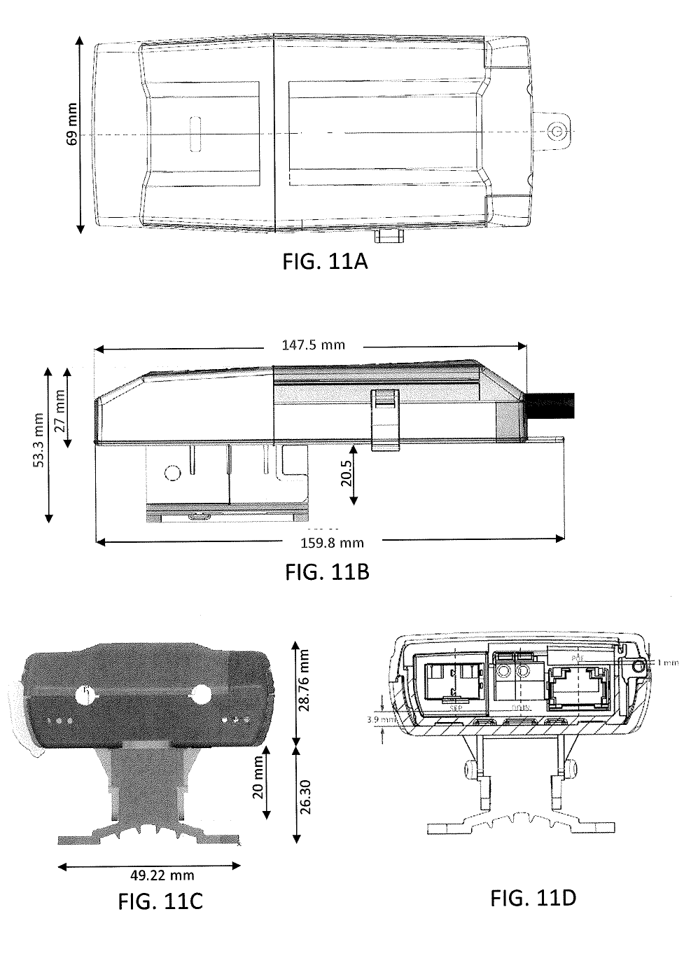

FIGS. 10A-10C show top, bottom and side views, respectively of the same variation of the Extender shown in FIGS. 9A-9D. In this example, the indicator light 905 is positioned near the top of the housing. A door 1003 encloses an inner portion of the housing (not shown in FIGS. 10A-10C). The door includes a latch 1005. As mentioned, the back of the housing may include a mount region 1009. FIGS. 11A-11D illustrate the extender housing shown in FIGS. 9A-10C and provide exemplary dimensions (in mm).

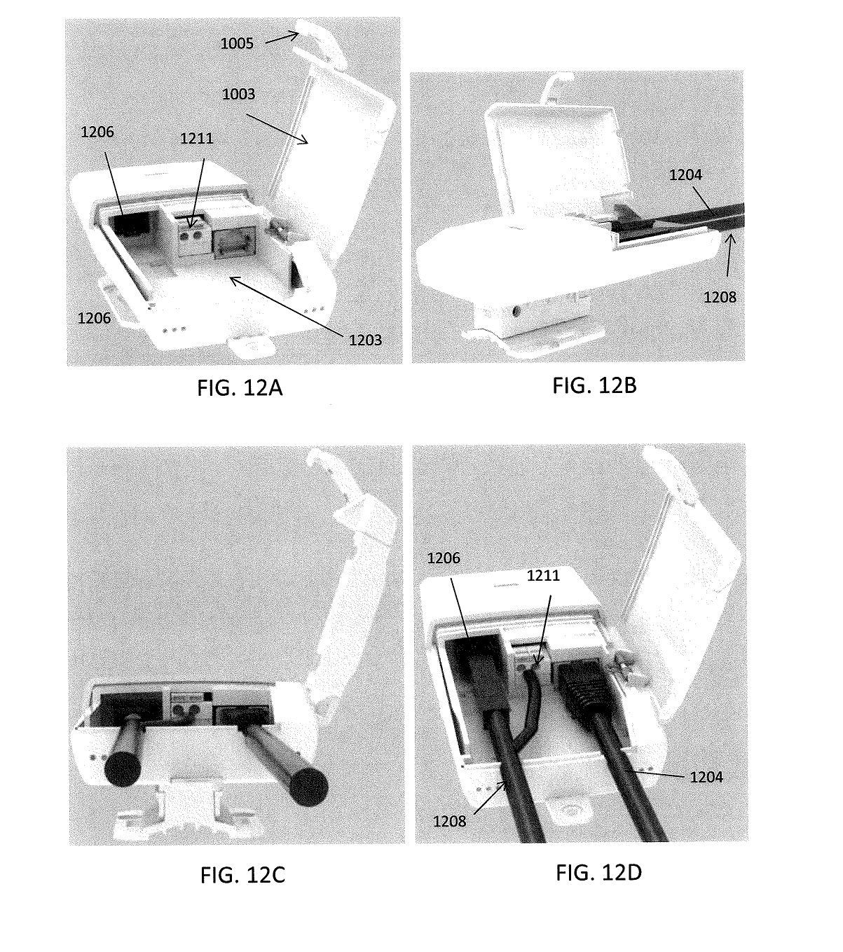

For example, FIG. 11A shows the width of the housing, and FIGS. 11B and 11C illustrate the length and thicknesses of various regions. FIG. 11D is a sectional view through the internal housing of the device and the mount region. The internal housing region is shown in more detail in FIGS. 12A-12D.

In FIG. 12A, an internal chamber 1203 region of the extender is shown as well as the cover 1003 and latch 1005 for sealing the inner chamber closed. The housing forming the inner chamber 1203 encloses the connectors for the hybrid fiber optic and power over Ethernet cable (including the transducer), and the connector for the PoE cable that can connect to a client device (e.g., router, antenna, etc.). The housing may include openings/passages (which may be sealed/sealable) allowing passage of the cables out of the inner chamber. The housing may also enclose additional components, including a PoE adapter, and any additional circuitry.

FIG. 12B shows a side view of the extender of FIG. 12A, illustrating the housing door open and the hybrid fiber optic and power over Ethernet cable and PoE cable connected and exiting the bottom of the extender. FIG. 12C shows a bottom view.

In the top perspective view of FIG. 12D, the hybrid fiber optic and power over Ethernet cable terminates in a SFP (transceiver) connected to the optical line (not visible) and is shown also connected to a data connector within the inner chamber of the housing. The DC power lines of the hybrid cable 1208 are shown connected to a power connector 1211, 1505. The PoE cable 1204 connects to an internal port (connector) and connects to the client device, providing an electrical data connection as well as potentially a connection for DC power.

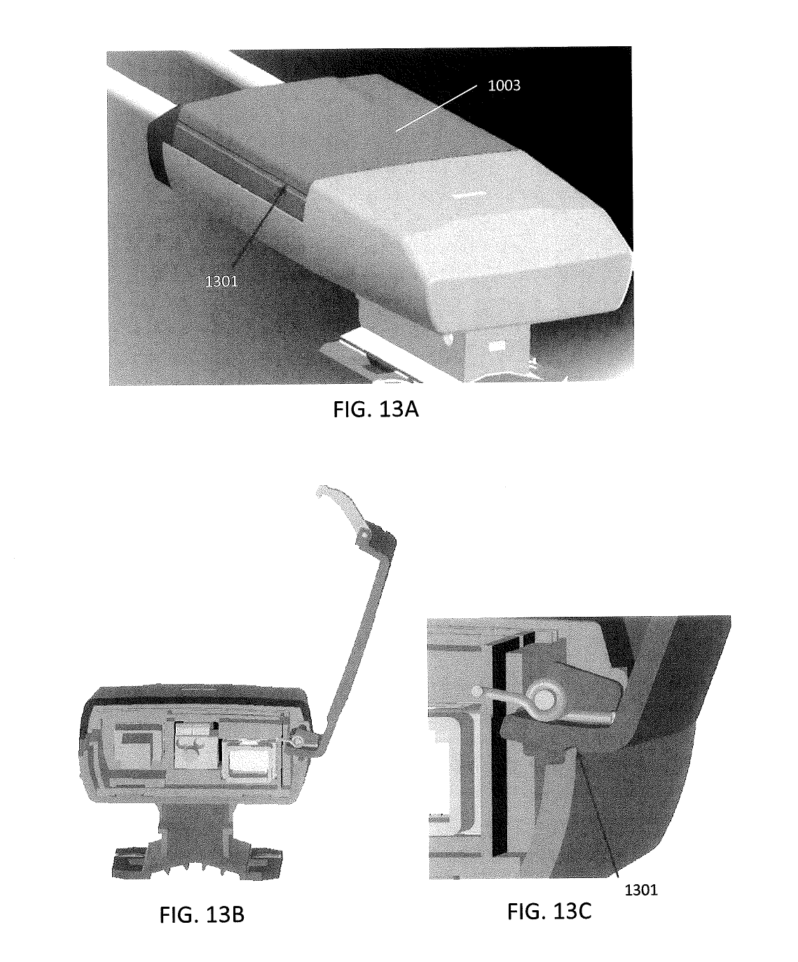

The cover 1003 may be opened widely and may be closed completely, forming a weather-proof enclosure to prevent environmental (e.g., rain, snow, etc.) interference with the connections. FIGS. 13A-13C illustrate examples of covers that may be used. In these examples, the cover is hinged to one side of the enclosure for the extender and may include a channel 1301 or other structure to allow the cover/door to be opened sufficiently widely to permit easy access for connecting/disconnecting the DC power, data, etc. In FIG. 13B, the section through the apparatus in the region of the inner chamber shows the hinged motion of the cover, also shown in greater detail in FIG. 13C.

In some variations the housing door may seal or enclose sufficiently to prevent water access from weather. The housing may also be adapted to prevent water access (e.g., weatherproofed) by including seals, channels or the like. For example, in FIGS. 15A and 15B the housing includes a plurality of drains (channels) 1305 that may remove water from around the housing opening. The housing opening may also include a gasket or other seal material. In some variations the transducer is incorporated into the extender, although it may be coupled separately to the extender after or before connection to the hybrid cabling. For example, the hybrid cabling may include on optical connector (e.g., pin, plug, connector, etc.) connected to the optical fiber that attaches to a transducer; alternatively the optical fiber may be directly connected to the transducer.

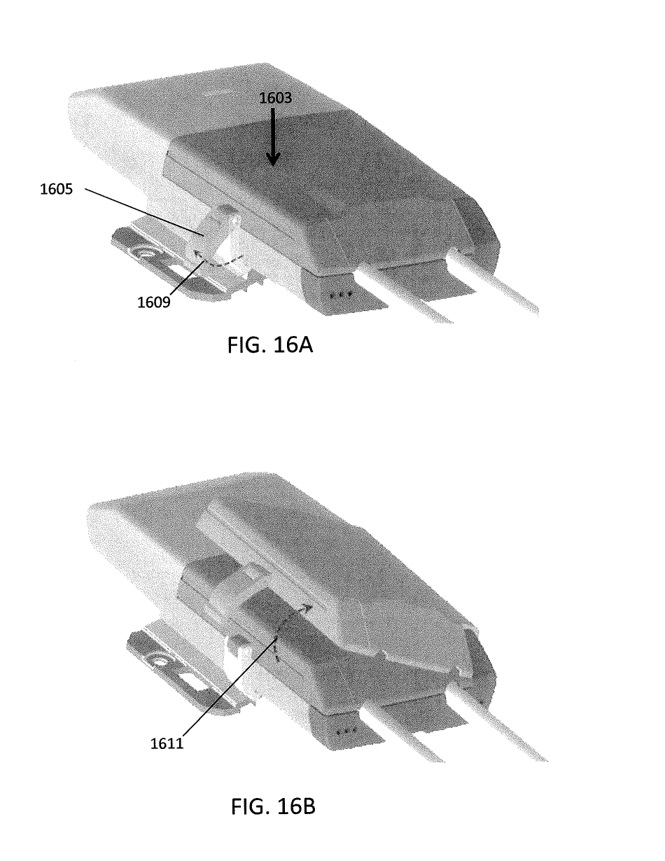

In operation, the door may be opened or closed by operating the latch (as illustrated in FIGS. 16A-16B) and pushing on the housing door. For example, in FIG. 16A, the housing door may be opened by pulling up on the latch 16 (indicated by arrow 1609) and by pushing down on the door (arrow 1603). In some variations the two motions (switching the latch and pushing on the door) must be performed in order; e.g., the latch may not be operable unless there is force pushing against the door. This may prevent inadvertent opening of the door. Thereafter, the door may be opened, as shown in FIG. 16B (arrow 1611).

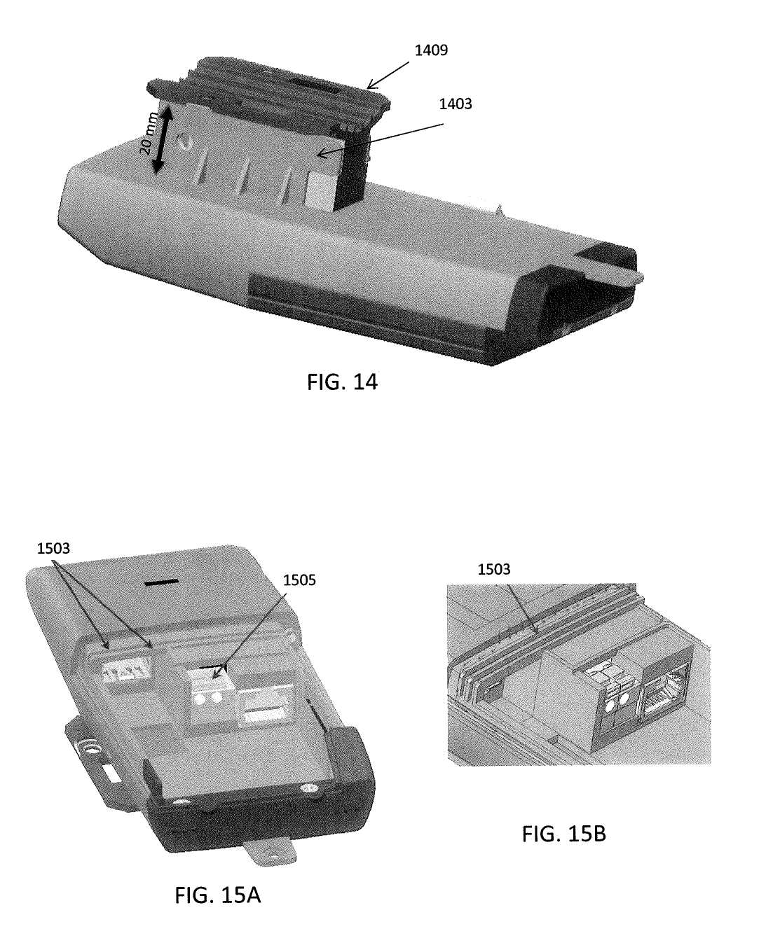

As mentioned above, any of the extenders described herein may be adapted to be attached directly to a post, pole, wall, or the like, and may include a mounting region, as shown in FIGS. 9A-9D and 10B. FIG. 14 shows another variation of an extender having a portion of a mount 1403 integrated into the housing; in some variations the mount may be completely integrated or completely separated from the housing. In FIG. 14, the mount includes a surface 1409 that is adapted to rest on/against a support surface (wall, pole, post, etc.). The surface in this example extends (T-like) from a neck region. The mount holding region of the extender housing 1403 may include a clip, clasp, or other securing element that holds the mount within the mount holding region securely. This may be lockable. In FIG. 14, the mount holding region may be configured to allow sufficient space (e.g., 20 mm) for an operator's fingers to be inserted between the mount and the extender housing to release and/or engage the mount.

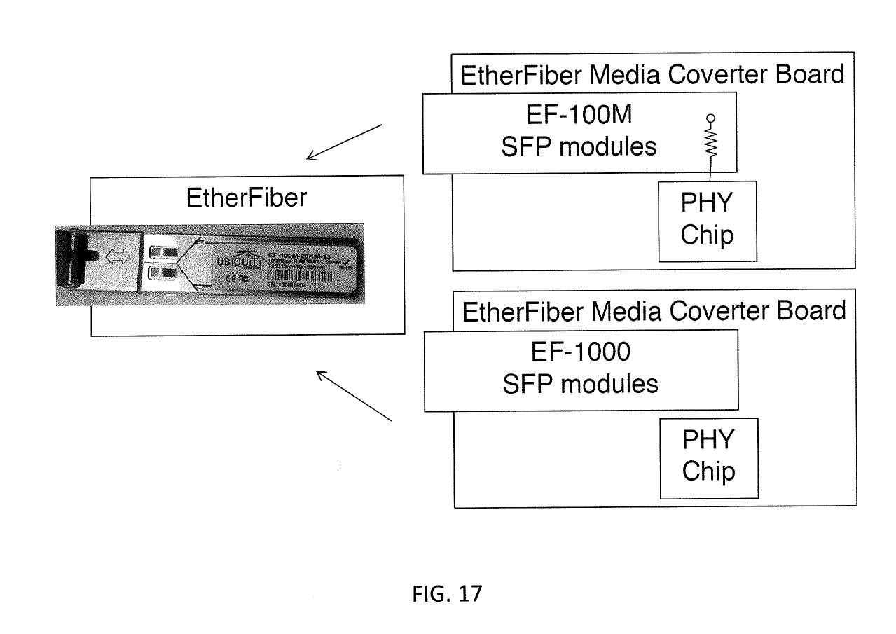

Any of the apparatuses described herein may be configured to indicate what the rate of transmission of data is, and/or to select the data transmission rate. In particular, the data transmission rate though the transducers (converting between electrical and optical transmission) may be monitored and/or regulated. For example, a system including a transducer may further include detection of the speed rate for transmission. In one variation the apparatus includes a media converter that is adapted to auto-detect the speed rate (e.g., of the SFP module). As illustrated in FIG. 17A a resistor (e.g., pull-up/pull-down resistor) may be included in a 100 Mbps module that detects the speed rate of the SFP module automatically. The pull-up/pull-down resistor in FIG. 17 is connected to a rate-select pin of an SFP module (an optional input pin in many commercially available SFP transducers). By using this pin as an output pin, the apparatus may indicate the speed of the SFP module. One PHY chip detects the level of the rate-select for this component, and may set the link speed to be 100 Mbps automatically based on this output, without requiring an additional MCU or controller.

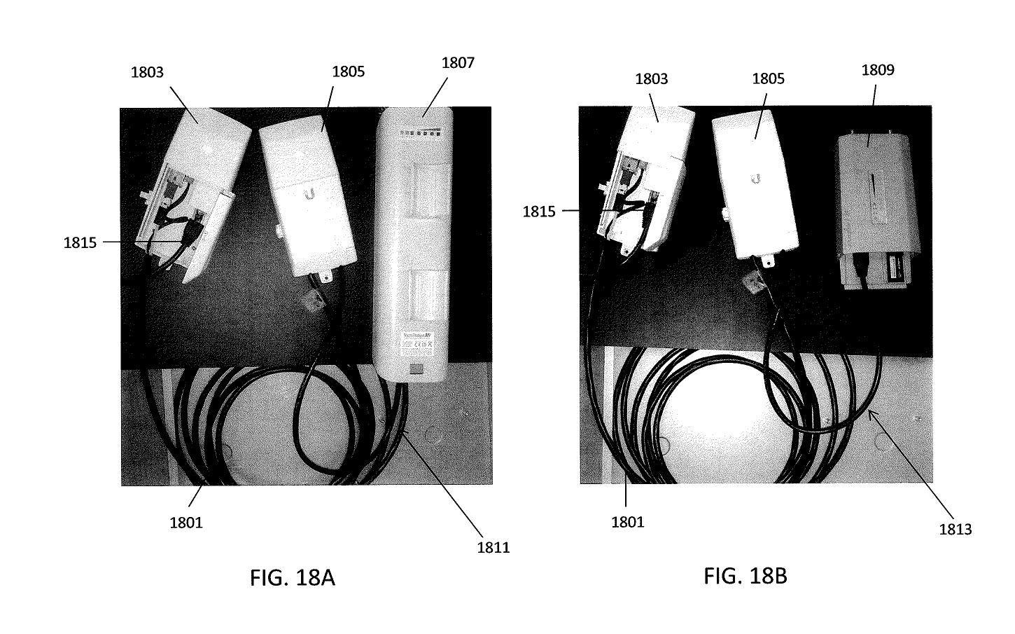

In operation, any of the hybrid fiber optic and power over Ethernet cable apparatuses described herein may provide DC power and optically transmitted data to any appropriate remote device, and particularly PoE devices. FIGS. 18A and 18B illustrate two examples. In FIG. 18A the apparatus includes a pair of extenders at each end of a hybrid fiber optic and power over Ethernet cable. For example, in FIG. 18A a first 1803 and a second 1805 extender are each attached to a hybrid fiber optic and power over Ethernet cable 1801. The first extender 1803 is also connected to a source of electrically transmitted data and DC power through a PoE cable 1815. For example, the PoE cable may be connected to a PoE Adapter (providing DC power) and/or a router (providing electrically-encoded data). The second extender also connects via a PoE cable 1811 (transmitting electrical signals and DC power) to an Ethernet device adapted to receive power from the PoE cable (e.g., antenna 1807). In FIG. 18A the antenna (client) device is a Ubiquiti NanoStation M2 (receiving 24 VDC).

FIG. 18B shows a similar set up, in which a PoE cable 1813 connects to the second extender to receive the data that was optically transmitted through the hybrid cable and is transmitted to client device 1809 (antenna). In FIG. 18B, the antenna client device is a Ubiquiti Rocket M5 Titanium device (operating at 48 VDC).

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A fiber optic power over Ethernet (PoE) cable to both provide power and optically communicate signals between devices, the cable comprising:
an elongate length of hybrid fiber cabling having an outer jacket surrounding both an optical fiber extending the length of the hybrid fiber cabling and an electrically conductive power line extending the length of the hybrid fiber cabling;
a first power connector configured to transmit DC power that is coupled to a first end of the electrically conductive power line;
a second power connector configured to transmit DC power that is coupled to a second end of the electrically conductive power line;
a first optical data connector configured to connect to a first transceiver that converts electrical signals into optical signals and optical signal into electrical signals, wherein the first optical data connector is coupled to a first end of the optical fiber; and
a second optical data connector coupled to a second end of the optical fiber and configured to connect to a second transceiver that converts optical signals from the optical fiber into electrical signals and converts electrical signals into optical signals for transmission on the optical fiber.

2. A fiber optic power over Ethernet (PoE) cable that provides both power and optical transmission of data to a device, the cable comprising:
an elongate length of hybrid fiber cable comprising an outer jacket surrounding an optical fiber extending the length of the hybrid fiber cable, and a power line comprising an electrical conductor extending the length of the hybrid fiber cable;
a first power connector connected to a first end of the power line and configured to transmit DC power;
a second power connector connected to a second end of the power line and configured to transmit DC power;
a first transceiver connected to a first end of the optical fiber through and configured to convert electrical signals into optical signals for transmission on the optical fiber and to convert optical signals from the optical fiber into electrical signals; and
a second transceiver connected to a second end of the optical fiber and configured to convert electrical signals into optical signals for transmission on the optical fiber and to convert optical signals from the optical fiber into electrical signals.

3. The cable of claim 2, wherein the first transducer is connected to a first end of the optical fiber through a first optical data connector, and wherein the second transducer is connected to the second end of the optical fiber through a second optical data connector.

4. The cable of claim 1, further comprising the first transceiver, wherein the first transceiver is coupled to the first optical data connector and converts between electrical and optical signals.

5. The cable of claim 1, further comprising the second transceiver wherein the second transceiver is coupled to the second optical data connector and converts between electrical and optical signals.

6. The cable of claim 1, further comprising an RJ45 connector that is coupled to the first optical data connector and the first power connector.

7. The cable of claim 1, further comprising a male RJ45 connector that is coupled to the first optical data connector and the first power connector.

8. The cable of claim 1, further comprising a connector that is coupled to the first optical data connector and the first power connector wherein the connector is configured to support 10/100/1000 BaseT operation.

9. The cable of claim 1 or 2, wherein the optical fiber is a single-mode optical fiber.

10. The cable of claim 1 or 2, wherein the first and second transceivers are configured as single fiber bi-directional transceivers.

11. The cable of claim 1 or 2, wherein the first and second transceivers are configured to support 100Base-FX and 1000-X optical fiber modules.

12. The cable of claim 1 or 2, further comprising a second electrically conductive power line within the outer jacket and coupled to the first power connector.

13. The cable of claim 1 or 2, wherein the hybrid fiber cabling comprises a waterproof barrier surrounded by the outer jacket.

14. The cable of claim 2, further comprising an output indicating the speed of the transducer.

15. A method of optically transmitting and providing power to an Ethernet device and from an Ethernet data source using a hybrid fiber optic and power over Ethernet cable, the method comprising:
receiving electrically transmitted data from the Ethernet data source;
optically transmitting the electrically transmitted data from a first end of the hybrid fiber optic and power over Ethernet cable to a second end of the hybrid fiber optic and power over Ethernet cable;
electrically transmitting the optically transmitted data from the second end of the hybrid fiber optic and power over Ethernet cable to the Ethernet device;
transmitting DC power from the first end of the hybrid fiber optic and power over Ethernet cable to the second end of the hybrid fiber optic and power over Ethernet cable; and
powering the Ethernet device from the DC power transmitted through the hybrid fiber optic and power over Ethernet cable.

16. A method of optically transmitting and providing power to an Ethernet device and from an Ethernet data source using a hybrid fiber optic and power over Ethernet cable, the method comprising:
electrically transmitting data from the Ethernet data source to a first end of the hybrid fiber optic and power over Ethernet cable;
transmitting DC power from the first end of the hybrid fiber optic and power over Ethernet cable to a second end of the hybrid fiber optic and power over Ethernet cable;
converting the data for optical transmission and optically transmitting the data through the hybrid fiber optic and power over Ethernet cable;
converting the data for electrical transmission and electrically transmitting the data from the second end of the hybrid fiber optic and power over Ethernet cable to the Ethernet device; and
powering the Ethernet device from the DC power transmitted through the hybrid fiber optic and power over Ethernet cable.

17. The method of claim 15 or 16, further comprising connecting the Ethernet device to the first end of the hybrid fiber optic and power over Ethernet cable using a power over Ethernet (PoE) cable.

18. The method of claim 15 or 16, further comprising connecting the Ethernet device to the first end of the hybrid fiber optic and power over Ethernet cable though a first media converter.

19. The method of claim 15 or 16, further comprising connecting the Ethernet data source to the second end of the hybrid fiber optic and power over Ethernet cable using a second Ethernet cable.

20. The method of claim 15 or 16, further comprising connecting the Ethernet data source to the second end of the hybrid fiber optic and power over Ethernet cable using a second media converter.

21. The method of claim 15 or 16, further comprising providing DC power to the hybrid fiber optic and power over Ethernet cable from the Ethernet data source.

22. The method of claim 15 or 16, wherein the Ethernet data source comprises a PoE switch.

23. The method of claim 15 or 16, wherein the Ethernet data source comprises a router.

24. The method of claim 15 or 16, wherein the Ethernet device comprises an antenna.

25. The method of claim 15 or 16, wherein optically transmitting the data through the hybrid fiber optic and power over Ethernet cable comprises optically transmitting though a hybrid fiber optic and power over Ethernet cable that is extends outdoors.

26. The method of claim 15 or 16, wherein the DC power is transmitted by the hybrid fiber optic and power over Ethernet cable concurrently with optically transmitting the data through the hybrid fiber optic and power over Ethernet cable.

27. The method of claim 15 or 16, further comprising detecting the speed rate of the transmission of data.

28. The method of claim 15 or 16, further comprising indicating the speed rate of the transmission of data.

29. An extender device for connecting a Power over Ethernet (PoE) device to a remote device using a hybrid fiber optic and power over Ethernet cable, the device comprising:
a first Ethernet connector having a first power contact configured to transmit DC power and a first data contact configured to carry electrical signals;
a second power contact configured to transmit DC power;
a second data contact configured to connect to a transceiver to convert electrical signals from the second data contact into optical signals and to convert optical signals into electrical signals to the one or more data contacts; and
a housing surrounding the first connector and the transceiver.

30. An extender device for connecting a Power over Ethernet (PoE) device to a remote device using a hybrid fiber optic and power over Ethernet cable, the device comprising:
a first connector having a first power contact configured to transmit DC power and a data contact configured to carry electrical signals;
a second data contact;
a transceiver connected to the second data contact and configured to convert electrical signals from the second data contact into optical signals for transmission on an optical fiber, and to convert optical signals from an optical fiber into electrical signals to be transmitted by the second data contact;
a second power contact electrically connected to the first power contact and configured to transmit DC power; and
a housing at least partially enclosing the first connector and the transceiver.

31. The device of claim 29, further comprising the transceiver connected to the second data contact, wherein the transceiver is configured to couple to an optical fiber.

32. The device of claim 30 or 31, further comprising an optical fiber connector for connecting an optical fiber to the transducer.

33. The device of claim 30 or 31, wherein the transceiver is a configured to couple with a single-mode optical fiber.

34. The device of claim 30 or 31, wherein the transceiver is configured to support 100Base-FX and 1000-X optical fiber modules.

35. The device of claim 29 or 30, wherein the housing forms a weatherproof enclosure surrounding the first connector and the transceiver.

36. The device of claim 29 or 30, further comprising a DC power source within the housing that is coupled to the second power contact and configured to receive AC power and provide DC power to the power contact of the connector.

37. The device of claim 29 or 30, wherein the first connector comprises an RJ45 connector.

38. The device of claim 29 or 30, wherein the first connector comprises a male RJ45 connector.

39. The device of claim 29 or 30, wherein the first connector is configured to support 10/100/1000 BaseT operation.

40. The device of claim 29 or 30, wherein the transceiver is configured as single fiber bi-directional transceiver.

41. The device of claim 30 or 31, further comprising an output indicating the speed of the transducer.

42. An extender for connecting a Power over Ethernet (PoE) device to a remote device using a hybrid fiber optic and power over Ethernet cable, the extender comprising:
a connector having a power contact configured to transmit DC power a data contact configured to carry electrical signals;
a transceiver connected to a second data contact of the first connector and configured to convert electrical signals from the one or more data contacts into optical signals and to convert optical signals into electrical signals to the one or more data contacts;
an optical connector coupled to the transceiver to connect to an optical fiber;
a DC power source configured to receive AC power and provide DC power to the power contact of the connector; and
a housing enclosing the transceiver and DC power source.
